(19) United States
(12) Patent Application Publication
(10) Pub. No.: US 2026/0323473 A1
(43) Pub. Date: Oct. 15, 2026

(54) MULTI-ACCESS POINT COORDINATION BASED ON LINK PRIORITY

(71) Applicant: KONINKLIJKE PHILIPS N.V., Eindhoven (NL)

(72) Inventors: Esmael Hejazi Dinan, Reston, VA (US); Jeongki Kim, Seoul (KR); Leonardo Alisasis Lanante, Reston, VA (US); Jiayi Zhang, Rockville, VA (US)

(21) Appl. No.: 19/485,297

(22) PCT Filed: May 14, 2024
(86) PCT No.: PCT/EP2024/063209

§ 371 Date: Nov. 18, 2025

Related U.S. Application Data
(60) Provisional application No. 63/467,340, filed on May 18, 2023.

(51) Int. Cl. H04W 40/12; H04W 88/08

(52) U.S. Cl. CPC H04W 40/12; H04W 88/08

(57) ABSTRACT

To improve the operation of multi-link devices, there is provided methods, devices and systems. In an example, there is a device which is arranged to act as a first access point (AP) and perform operations comprising receiving, from a second AP, a first frame indicating a priority of a first link, of a plurality of links, for communicating traffic of a first category via the first link by the second AP, and transmitting, via a second link of the plurality of links, a second frame comprising traffic of a second category, the second link selected based on the priority of the first link. The device may be arranged to select the second link for the transmitting of the second category.

### FIELD

The present invention relates to wireless networks, in particular but not limited to those using local area technologies such as IEEE 802.11.

### BACKGROUND

Modern wireless networks are often densely deployed and devices need to be able to adapt to changing situations. In other words, achieving flexibility is desirable, even with complicated devices. Also, requirements for low-latency traffic may result in additional constraints.

### SUMMARY

The inventors have realized that where multi-link devices (MLDs) are used and there is a requirement for the transmission of low-latency traffic, a situation may arise where a two devices are using multi-link connections. In particular, the inventors have realized that that issues may arise when a MLD non-AP STA hears a frame transmitted an AP-to-AP frame on one of the multi-links. The STA may postpone transmission of what might be urgent (e.g. low-latency) traffic. In the case of IEEE 802.11, this may involve the STA settings its NAV. Alternatively, the MLD STA may fail to hear the AP-AP frame and proceed with a transmission which interferes with the AP-AP frame.

Accordingly, embodiments and aspects of the invention are defined in the appended claims.

In an aspect, there is provided a method comprising receiving, by a first access point (AP) from a second AP, a first frame indicating a priority of a first link, of a plurality of links, for communicating traffic of a first category via the first link by the second AP, selecting, by the first AP and based on the priority of the first link, a second link of the plurality of links, for transmitting traffic of a second category to the second AP and transmitting, by the first AP to the second AP and via the second link, a second frame comprising the traffic of the second category.

In an aspect, there is provided a method comprising receiving, by a first access point (AP) from a second AP, a first frame indicating a priority of a first link, of a plurality of links, for communicating traffic of a first category via the first link by the second AP; and transmitting, by the first AP, via a second link of the plurality of links, a second frame comprising traffic of a second category, the second link selected based on the priority of the first link.

According to an embodiment, transmitting the second frame comprises transmitting the second frame to the second AP or to a first STA.

According to an embodiment, receiving the first frame comprises receiving the first frame via the first link or the second link.

According to an embodiment, the priority of the first link indicates that the second AP communicates exclusively traffic of the first category via the first link.

According to an embodiment, the priority of the first link indicates that the second AP does not communicate traffic of the first category via the first link.

According to an embodiment, a traffic stream of the first category is mapped to the first link at the second AP.

According to an embodiment, the traffic of the first category comprises low latency traffic.

According to an embodiment, the traffic of the first category comprises traffic between the second AP and a second STA associated with the second AP.

According to an embodiment, the traffic of the second category comprises traffic between the first AP and the second AP.

According to an embodiment, the first frame further indicates a priority of the second link for communicating traffic of the first category via the second link by the second AP.

According to an embodiment, the first frame further comprises a period for communicating traffic of the first category via the first link by the second AP.

According to an embodiment, the first frame comprises a management frame.

According to an embodiment, the management frame comprises a beacon frame comprising an element indicating the priority of the first link.

According to an embodiment, the management frame comprises an action frame comprising an action field indicating the priority of the first link.

According to an embodiment, there is transmitting, by the first AP to the second AP, a third frame to solicit the first frame.

According to an embodiment, there is transmitting, by the first AP to the second AP, a fourth frame in response to the first frame.

According to an embodiment, the first AP and the second AP form a multi-AP group. According to an embodiment, the first AP or the second AP comprises a multi-link device (MLD).

In an aspect there is a device arranged to act as a first access point (AP) and perform operations comprising receiving, from a second AP, a first frame indicating a priority of a first link, of a plurality of links, for communicating traffic of a first category via the first link by the second AP, and transmitting, via a second link of the plurality of links, a second frame comprising traffic of a second category, the second link selected based on the priority of the first link.

According to an embodiment, the device is arranged to select the second link for the transmitting of the second category.

In an aspect, there is provided a system comprising a device and second AP as described herein.

In an aspect, there is provided a computer program product, stored on a computer readable medium, arranged, when run on a processor, to execute the method as described herein.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example Medium Access Control (MAC) frame format.

FIG. 4 illustrates an example management frame which may be used as an action frame.

FIG. 5 illustrates an example control frame which may be used as a trigger frame.

FIG. 6 illustrates an example data frame which may be used as a Quality of Service (QoS) null frame.

FIG. 7 illustrates an example format of a physical layer (PHY) protocol data unit (PPDU).

FIG. 8 illustrates an example reference model for a multi-link device (MLD).

FIG. 9 illustrates an example of an AP MLD and an associated non-AP MLD.

FIG. 10 illustrates an example of a multi-link setup between an AP MLD and a non-AP MLD.

FIG. 11 illustrates an example of a traffic identifier (TID)-to-link mapping in a multi-link communication environment.

FIG. 12 illustrates an example multi-AP network.

FIG. 13 illustrates an example network that includes a coordinated AP set.

FIG. 14 illustrates an example multi-AP operation procedure.

FIG. 15 illustrates an example multi-AP sounding phase.

FIG. 16 illustrates an example multi-AP downlink data transmission phase.

FIG. 17 illustrates an example multi-AP uplink data transmission phase.

FIG. 18 illustrates an example multi-AP information exchange phase.

FIG. 19 illustrates an example of target wake time (TWT).

FIG. 20 illustrates an example multi-AP network supporting multi-link operation (MLO).

FIG. 21 illustrates an example multi-AP procedure in a multi-link environment.

FIG. 22 illustrates an example multi-AP coordination procedure in a multi-link environment according to an embodiment.

FIG. 23 illustrates another example multi-AP coordination procedure in a multi-link environment according to an embodiment.

FIG. 24 illustrates another example multi-AP coordination procedure in a multi-link environment according to an embodiment.

FIG. 25 illustrates another example multi-AP coordination procedure in a multi-link environment according to embodiments.

FIG. 26 illustrates an example beacon frame which may be used according to embodiments.

FIG. 27 illustrates an example action frame which may be used according to embodiments.

FIG. 28 illustrates an example process according to an embodiment of the present disclosure.

FIG. 29 illustrates an example process according to an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

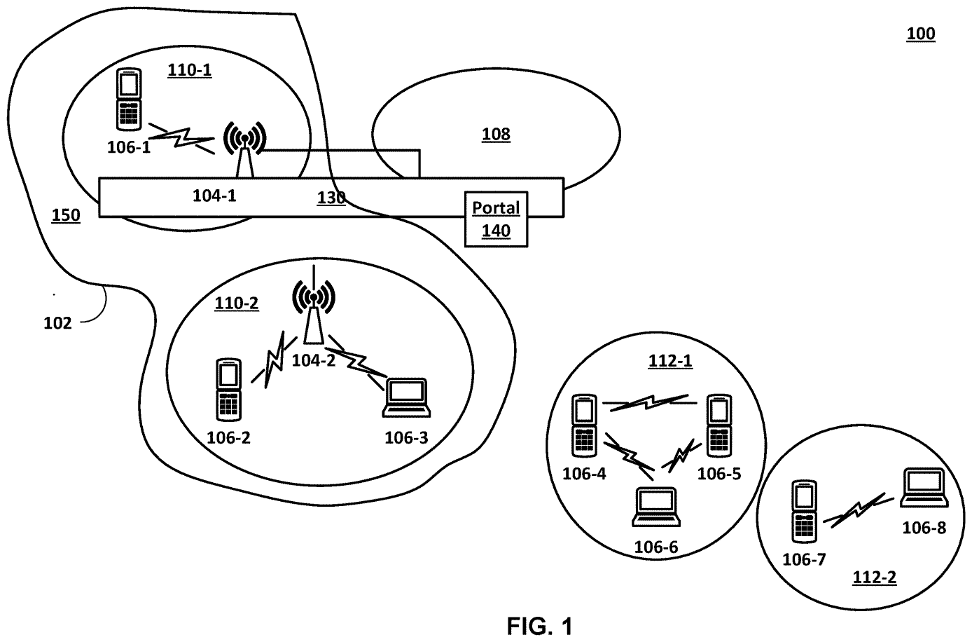

FIG. 1 illustrates example wireless communication networks 100 in which embodiments of the present disclosure may be implemented.

As shown in FIG. 1, the example wireless communication networks 100 may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STA 106-2 and STA 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, AP 104-1 and AP 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STA 106-4, STA 106-5, and 106-6 may be configured to form a first IBSS 112-1. Similarly, STA 106-7 and STA 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 1120 MHz by bonding together multiple 20 MHz channels.

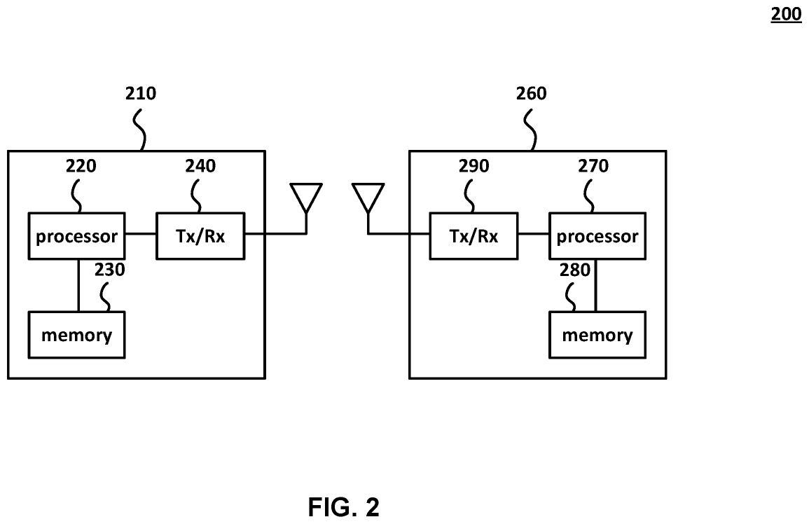

FIG. 2 is a block diagram 200 illustrating example implementations of a STA 210 and an AP 260. As shown in FIG. 2, STA 210 may include at least one processor 220, a memory 230, and at least one transceiver 240. AP 260 may include at least one processor 270, memory 280, and at least one transceiver 290. Processor 220/270 may be operatively connected to transceiver 240/290.

Transceiver 240/290 may be configured to transmit/receive radio signals. In an embodiment, transceiver 240/290 may implement a PHY layer of the corresponding device (STA 210 or AP 260).

In an embodiment, STA 210 and/or AP 260 may be a multi-link device (MLD), that is a device capable of operating over multiple links as defined by the IEEE 802.11be standard amendment. As such, STA 210 and/or AP 260 may each have multiple PHY layers. The multiple PHY layers may be implemented using one or more of transceivers 240/290.

Processor 220/270 may implement functions of the PHY layer, the MAC layer, and/or the logical link control (LLC) layer of the corresponding device (STA 210 or AP 260).

Processor 220/270 and/or transceiver 240/290 may include application specific integrated circuit (ASIC), other chipset, logic circuit and/or data processor. Memory 230/280 may include read-only memory (ROM), random access memory (RAM), flash memory, memory card, storage medium and/or other storage unit.

When the embodiments are executed by software, the techniques (or methods) described herein can be executed with modules (e.g., processes, functions, and so on) that perform the functions described herein. The modules can be stored in memory 230/280 and executed by processor 220/270. Memory 230/280 may be implemented (or positioned) within processor 220/270 or external to processor 220/270. Memory 230/280 may be operatively connected to processor 220/270 via various means known in the art.

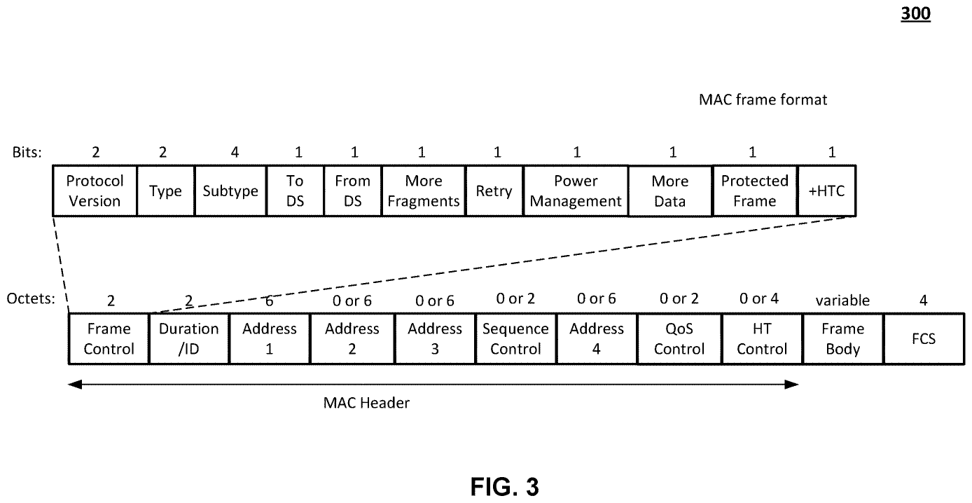

FIG. 3 illustrates an example format of a MAC frame 300. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, MAC frame 300 includes a MAC header, a variable length frame body, and a frame check sequence (FCS).

The MAC header includes a frame control field, an optional duration/ID field (not in PS-Poll frames), address fields, an optional sequence control field, an optional QoS control field (only in QoS Data frames), and an optional high throughput (HT) control field (only in +HTC frames).

The frame control field includes the following subfields: protocol version, type, subtype, To DS, From DS, more fragments, retry, power management, more data, protected frame, and high throughput control (+HTC).

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contains no frame body field.

The To DS subfield indicates whether a data frame is destined to the DS. The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (BUs) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that MAC frame 300 contains an HT control field. A frame that contains the HT Control field is referred to as a +HTC frame. A Control Wrapper frame is a +HTC frame.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the format of MAC frame 300. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which MAC frame 300 belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field. The control frame subtype for which HT control field is present is the control wrapper frame. A control frame that is described as +HTC (e.g., a request to send (RTS)+HTC, clear to send (CTS)+HTC, block acknowledgment (BlockAck)+HTC or block acknowledgment request (BlockAckReq)+HTC frame) implies the use of the control wrapper frame to carry that control frame.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

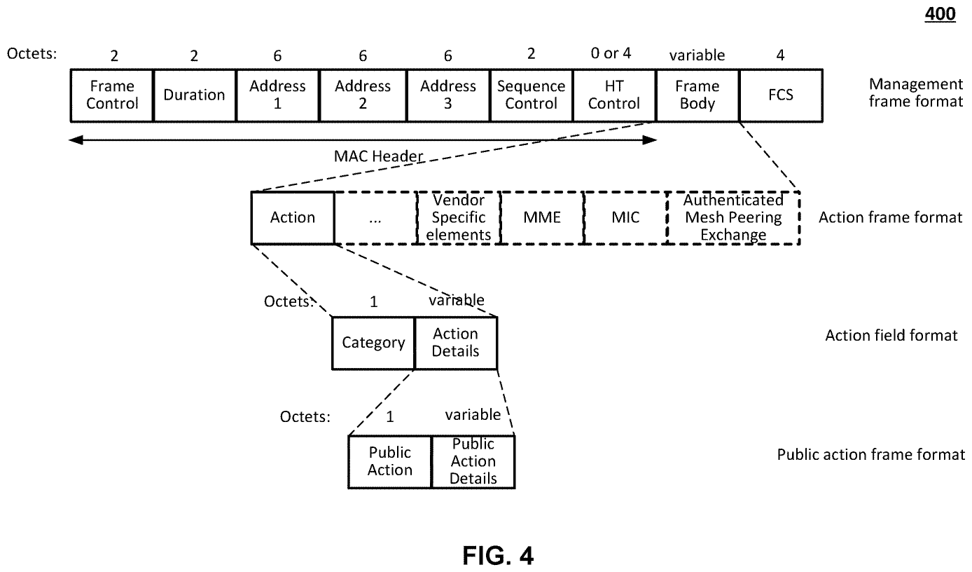

FIG. 4 illustrates an example management frame 400 which may be used as an action frame. In example, management frame 400 includes a MAC header, a variable length frame body, and a frame check sequence (FCS). The MAC header includes a frame control field, a duration field, an address 1 field, an address 2 field, an address 3 field, a sequence control field, and an optional HT control field. The presence of the HT control field is determined by the setting of a +HTC subfield of the frame control field.

As shown in FIG. 4, when used as an action frame, the frame body of management frame includes an action field, vendor specific elements, management message integrity code element (MME), message integrity code (MIC), and an authenticated mesh peering exchange element.

The action field includes a category field and an action details field. The action field provides a mechanism for specifying extended management actions. The category field indicates a category of the action frame. The action details field contains the details of the action requested by the action frame. For example, the action frame may be a public action frame. As shown in FIG. 4, in the public action frame format, the action details field includes a public action field, in the octet immediately after the category field, followed by a variable length public action details field.

One or more vendor specific elements are optionally present. These elements are absent when the category subfield of the Action field is vendor-specific.

The MME is present when management frame protection is negotiated, the frame is a group addressed robust Action frame, and (MBSS only) the category of the action frame does not support group addressed privacy as indicated by category values; otherwise not present.

The MIC element is present in a self-protected action frame if a shared pairwise master key (PMK) exists between the sender and recipient of this frame; otherwise not present.

The authenticated mesh peering exchange element is present in a self-protected action frame if a shared PMK exists between the sender and recipient of this frame; otherwise not present.

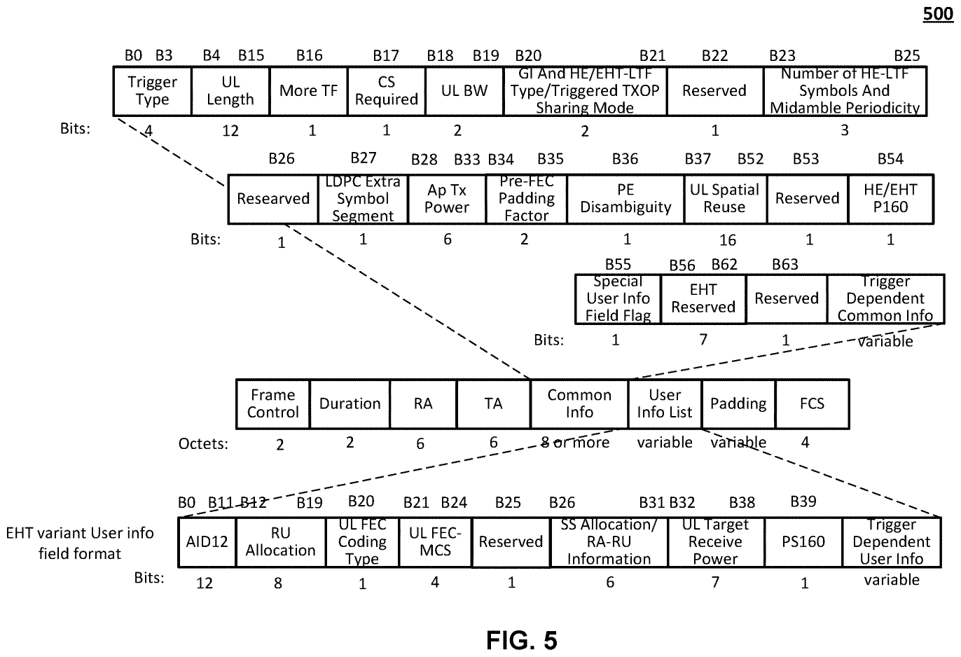

FIG. 5 illustrates an example format of a trigger frame 500. Trigger frame 500 may be used by an AP to allocate resources for and solicit one or more TB PPDU transmissions from one or more STAs. Trigger frame 500 may also carry other information required by a responding STA to transmit a TB PPDU to the AP.

As shown in FIG. 5, trigger frame 500 includes a Frame Control field, a Duration field, a receiver address (RA) field, a transmitter address (TA) field, a Common Info field, a User Info List field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 500 if trigger frame 500 is addressed to STAs that belong to a single BSS. The TA field is the transmitted BSSID if trigger frame 500 is addressed to STAs from at least two different BSSs of the multiple BSSID set.

The Common Info field specifies a trigger frame type of trigger frame 500, a transmit power of trigger frame 500 in dBm, and several key parameters of a TB PPDU that is transmitted by a STA in response to trigger frame 500. The trigger frame type of a trigger frame used by an AP to receive QoS data using UL MU operation is referred to as a basic trigger frame. A non-EHT non-AP HE STA interprets the Common Info field as HE variant. A non-AP EHT STA interprets the Common Info field as HE variant if B54 and B55 in the Common Info field are equal to 1; and interprets the Common Info field as EHT variant otherwise. The HE variant Common Info field and the EHT variant Common Info field use the same encoding method for the Trigger Type, UL Length, More TF, CS Required, LDPC Extra Symbol Segment, AP TX Power, Pre-FEC Padding Factor, PE Disambiguity, and Trigger Dependent Common Info subfields.

The User Info List field contains zero or more User Info fields. There are three variants for the User Info field, which are the Special User Info field, the EHT variant User Info field, and the HE variant User Info field.

The Special User Info field is a User Info field that does not carry the user specific information but carries the extended common information not provided in the Common Info field. If the Special User Info field is included in the Trigger frame, then the Special User Info Field Flag subfield of the EHT variant Common Info field is set to 0, otherwise it is set to 1. The Special User Info field is identified by an AID12 value of 2007 and is optionally present in a Trigger frame that is generated by an EHT AP. The Special User Info field, if present, is located immediately after the Common Info field of the Trigger frame and carries information for the U-SIG field of a solicited EHT TB PPDU. The PHY Version Identifier subfield indicates the PHY version of the solicited TB PPDU that is not an HE TB PPDU. The PHY Version Identifier subfield is set to 0 for EHT. Other values from 1 to 7 are reserved. The UL Bandwidth (BW) Extension subfield, together with the UL BW subfield in the Common Info field, indicates the bandwidth of the solicited TB PPDU from the addressed EHT STA (i.e., the bandwidth in the U-SIG field of the EHT TB PPDU). The EHT Spatial Reuse n subfield carries the values to be included in the corresponding Spatial Reuse n subfield in the U-SIG field of the EHT TB PPDU. The U-SIG Disregard And Validate subfield carries the values to be included in the Disregard and Validate subfields of the U-SIG field of the solicited EHT TB PPDUs. The presence and length of the Trigger Dependent User Info subfield in the Special User Info field depends on the variant of the Trigger frame.

The EHT variant User Info field contains a User Info field per STA addressed in trigger frame 500. The per STA User Info field includes, among others, an AID12 subfield, an RU Allocation subfield, a UL FEC Coding Type subfield, a UL EHT-MCS subfield, a Reserved subfield, a Spatial Stream (SS) Allocation/RA-RU information subfield, a UL Target Receive Power subfield, and a Power Save (PS) 160 subfield to be used by a STA in a TB PPDU transmitted in response to trigger frame 500, and a Trigger Dependent User Info subfield. The RU Allocation subfield in an EHT variant User Info field in a Trigger frame that is not an MU-RTS Trigger frame, along with the UL BW subfield in the Common Info field, the UL BW Extension subfield in the Special User Info field, and the PS160 subfield in the EHT variant User Info field, identifies the size and the location of the RU or MRU. The values of PS160 subfield and B0 of RU Allocation subfield indicate the 80 MHz frequency subblock in which the RU or MRU is located for 26-tone RU, 52-tone RU, 106-tone RU, 242-tone RU, 484-tone RU, 996-tone RU, 52+26-tone RU, and 106+26-tone RU. The values of PS160 subfield indicates the 160 MHz segment in which the RU or MRU is located for 2□996-tone RU, 996+484-tone MRU, and 996+484+242-tone MRU. The UL FEC Coding Type subfield of the User Info field indicates the code type of the solicited EHT TB PPDU. The UL FEC Coding Type subfield is set to 0 to indicate BCC and set to 1 to indicate LDPC. The UL EHT-MCS subfield of the User Info field indicates the EHT-MCS of the solicited EHT TB PPDU. The SS Allocation subfield of the EHT variant User Info field indicates the spatial streams of the solicited EHT TB PPDU. The UL Target Receive Power subfield indicates the expected receive signal power, measured at the AP's antenna connector and averaged over the antennas, for the EHT portion of the EHT TB PPDU transmitted on the assigned RU. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA. The RA-RU Information subfield is reserved in the EHT variant User Info field.

The Padding field is optionally present in trigger frame 400 to extend the frame length to give recipient STAs enough time to prepare a response for transmission one SIFS after the frame is received. The Padding field, if present, is at least two octets in length and is set to all 1 s.

The FCS field is used by a STA to validate a received frame and to interpret certain fields from the MAC headers of a frame.

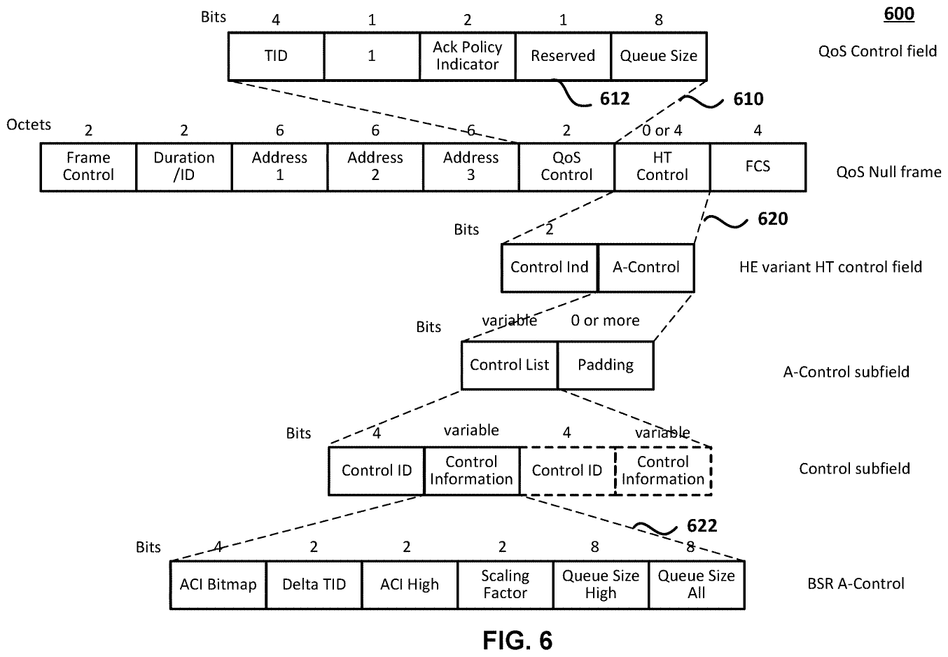

FIG. 6 illustrates an example data frame 600 which may be used as a QoS null frame. A QoS null frame refers to a QoS data frame with an empty frame body. QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an acknowledgment (Ack) policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the Ack policy followed upon delivery of the MPDU (e.g., normal Ack, implicit block Ack request, no Ack, block Ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine the TXOP duration assigned to the STA or to determine the uplink (UL) resources assigned to the STA.

In a frame sent by or to a non-high efficiency (non-HE) STA, the following rules may apply to the queue size value:

The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.

A queue size value of 0 is used solely to indicate the absence of any buffered traffic in the queue used for the specified TID.

A queue size value of 254 is used for all sizes greater than 64 768 octets.

A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:

$$QS = 16 \times UV , if SF is equal to 0 ;$$

$$1024 + 256 \times UV , if SF is equal to 1 ;$$

$$17408 + 20 \; 48 \times UV , if SF is equal to 2 ;$$

$$148480 + 32768 \times UV , if SF is equal to 3 and UV is less than 62 ;$$

$$> 2147328 , if SF is equal to 3 and UV is equal to 62 ;$$

$$Unspecified or Unknown , if SF is equal to 3 and UV is equal to 63 .$$

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 μs to 8160 μs in increments of 32 μs.

The HT control field may include an aggregated control (A-Control) subfield. The A-Control subfield may include a control list subfield including one or more control subfields.

The control subfield may be a BSR control subfield, which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

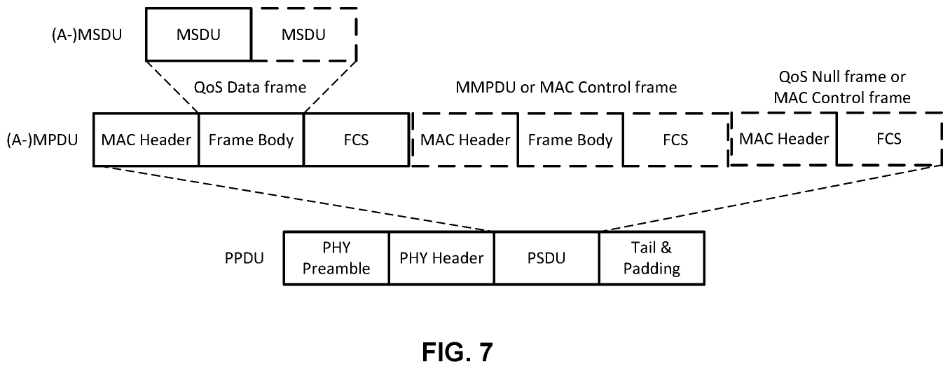

FIG. 7 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in an UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

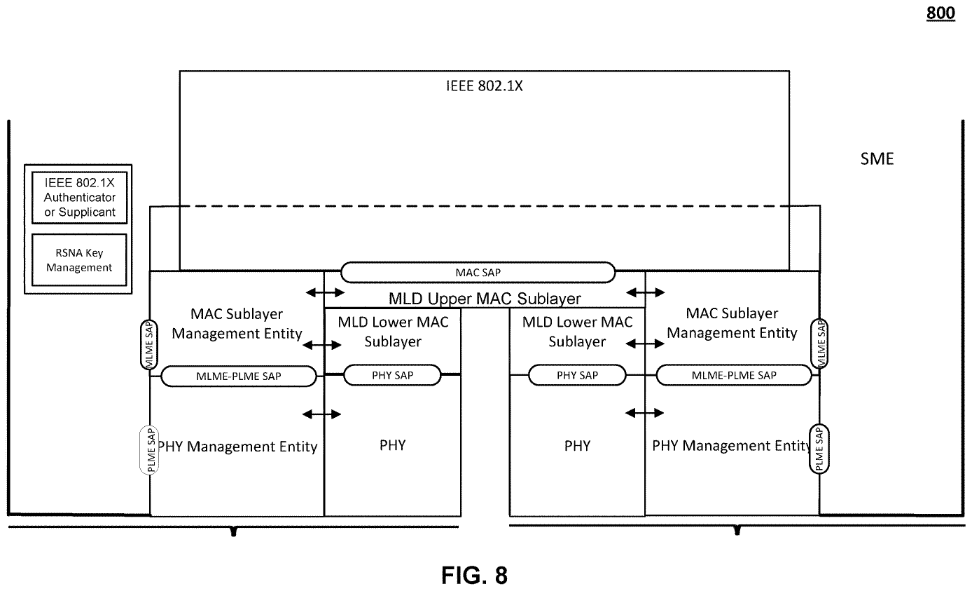

FIG. 8 illustrates an example reference model for a multi-link device (MLD). An MLD is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both the communicating AP MLD and non-AP MLD.

As shown in FIG. 8, an MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de) authenticate, (re)associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

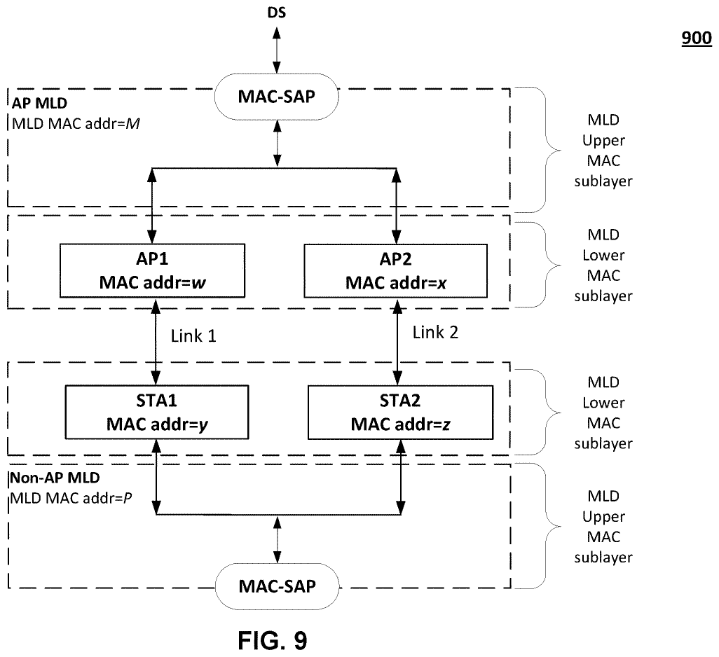

FIG. 9 illustrates an example of an AP MLD and an associated non-AP MLD.

As shown, the AP MLD has two affiliated APs (AP1 and AP2), and the non-AP MLD has two affiliated STAs (STA 1 and STA 2). The AP MLD and the non-AP MLD may be communicatively coupled by two links (Link 1 and Link 2.) Link 1 is established between AP1 and STA1, and link 2 is established between AP2 and STA2.

Generally, the MAC addresses of an MLD and of its affiliated STAs are different from one another. For example, as shown in FIG. 9, the AP MLD may have MAC address M, AP 1 may have MAC address w, and AP2 may have a MAC address x. Similarly, the non-AP MLD may have MAC address P, STA 1 may have MAC address y, and STA2 may have MAC address z.

As shown in FIG. 9, with each MLD, the MAC sublayer may be further divided into an MLD upper MAC sublayer and an MLD lower MAC sublayer. The MLD upper MAC sublayer (MLD) performs functionalities that are common across all links. The MLD lower MAC sublayer performs functionalities that are local to each link. Some of the functionalities require joint processing of both the MLD upper and the MLD lower MAC sublayers.

The MLD upper MAC sublayer functions may include:
Authentication, association, and reassociation (between an AP MLD and a non-AP MLD);
Security association (e.g., pairwise master key security association (PMKSA), pairwise transient key security association (PTKSA)) and distribution of group temporal key (GTK)/integrity GTK (IGTK)/beacon IGTK (BIGTK);
Sequence number (SN)/packet number (PN) assignment for frames to be encrypted by pairwise transient key (PTK) for unicast frames;
Encryption/decryption using PTK for unicast frames;
Selection of the MLD lower MAC sublayer for transmission (TID-to-link mapping);
Reordering of packets to ensure in-order delivery per each Block Ack session;
Block Ack scoreboarding for individually addressed frames (in collaboration with the MLD lower MAC sublayer); optionally, the MLD upper MAC sublayer delivers the Block Ack record on one link to the MLD lower MAC sublayer of other links; and
MLD level management information exchange/indication via the MLD lower MAC sublayer.

The MLD lower MAC sublayer functions may include:
Maintenance of link specific GTK/IGTK/BIGTK (between an AP affiliated with the AP MLD and a STA affiliated with the non-AP MLD);
Link-specific encryption/decryption/integrity protection and PN assignment using GTK/IGTK/BIGTK (between an AP affiliated with the AP MLD and a STA affiliated with the non-AP MLD);
Link specific management information exchange/indication (e.g., beacon);
Link specific control information exchange/indication (e.g., RTS/CTS, acknowledgements, etc.);
Power save state and mode;
MAC address filtering for frame reception; and
Block Ack scoreboarding for individually addressed frames (in collaboration with the MLD upper MAC sublayer); optionally, the MLD lower MAC sublayer receives the Block Ack record on the other links from the MLD upper MAC sublayer.

Multi-link (re)setup between a non-AP MLD and an AP MLD may include an exchange of (re)association request/response frames. A (re)association request/response frame exchange for a multi-link setup may include both frames carrying a basic multi-link element.

In the (re)association request frame, the non-AP MLD indicates the links that are requested for (re)setup and the capabilities and operational parameters of the requested links. The non-AP MLD may request to (re)set up links with a subset of APs affiliated with the AP MLD. The links that are requested for (re)setup and the capabilities and operation parameters of requested links are independent of existing setup links with an associated AP MLD and the capabilities and operation parameters of setup links.

In the (re)association response frame, the AP MLD may indicate the requested links that are accepted and the requested links that are rejected for (re)setup and the capabilities and operational parameters of the requested links. The AP MLD may accept a subset of the links that are requested for (re)setup. The (re)association response frame is sent to the non-AP STA, affiliated with the non-AP MLD, that sent the (re)association request frame.

An MLD that requests or accepts multi-link (re)setup for any two links ensures that each link is located on a different nonoverlapping channel. After successful multi-link (re)setup between a non-AP MLD and an AP MLD, the non-AP MLD and the AP MLD set up links for multi-link operation, and the non-AP MLD is (re)associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

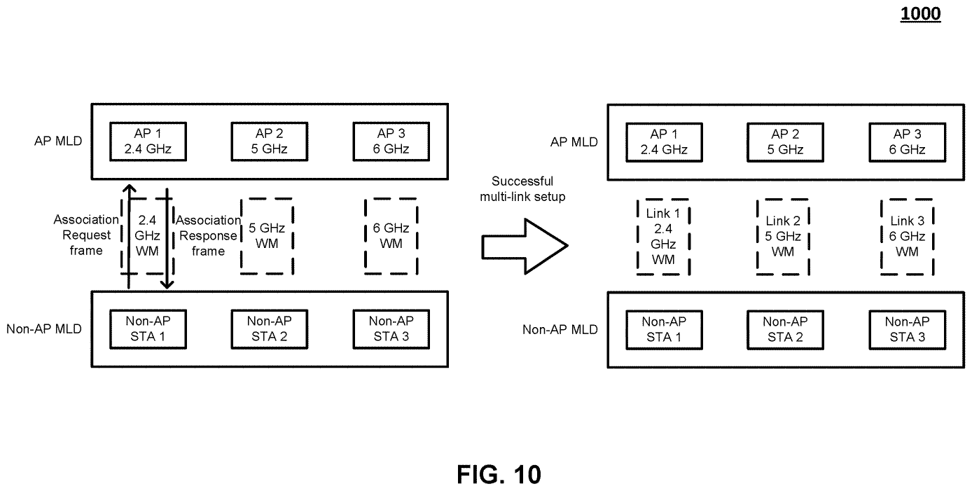

FIG. 10 illustrates an example of a multi-link setup between an AP MLD and a non-AP MLD. As shown, the AP MLD has three affiliated APs: AP 1 operating in the 2.4 GHz band, AP 2 operating in the 5 GHz band, and AP 3 operating in the 6 GHz band. The non-AP MLD has three affiliated STAs: non-AP STA 1 operating in the 2.4 GHz band, non-AP STA 2 operating in the 5 GHz band, and non-AP STA 3 operating in the 6 GHz band.

The non-AP MLD may initiate multi-link setup by non-AP STA 1 sending an association request frame to AP 1 affiliated with the AP MLD. In the association request frame, the transmitter address (TA) field is set to the MAC address of non-AP STA 1 and the receiver address (RA) field is set to the MAC address of AP 1. The association request frame includes a basic multi-link element that indicates the MLD MAC address of the non-AP MLD and complete information of non-AP STA 1, non-AP STA 2, and non-AP STA 3. The association request frame may request the setup of three links between the non-AP MLD and the AP MLD (a link between AP 1 and non-AP STA 1, a link between AP 2 and non-AP STA 2, and a link between AP 3 and non-AP STA 3).

The AP MLD may respond to the requested multi-link setup by AP sending an association response frame to non-AP STA 1 affiliated with the non-AP MLD. In the association response frame, the TA field is set to the MAC address of the AP 1 and the RA field is set to the MAC address of the non-AP STA 1. The association response frame includes a basic multi-link element that indicates the MLD MAC address of the AP MLD and complete information of AP 1, AP 2, and AP 3. The association response frame signals successful multi-link setup by the setup of three links between the non-AP MLD and AP MLD (link 1 between AP 1 and non-AP STA 1, link 2 between AP 2 and non-AP STA 2, and link 3 between AP 3 and non-AP STA 3).

By default, all TIDs at the non-AP MLD are mapped to all setup links for both uplink and downlink. The TID-to-link mapping mechanism allows an AP MLD and a non-AP MLD that performed or are performing multi-link setup to specify how UL and DL QoS traffic corresponding to different TIDs (e.g., between 0 and 7) may be assigned to the setup links. In a negotiated TID-to-link mapping, a TID may be mapped to a link set, which is a subset of setup links, ranging from a single setup link to all the setup links.

A setup link is defined as enabled for a non-AP MLD if at least one TID is mapped to that link either in DL or in UL, and is defined as disabled if no TIDs are mapped to that link both in DL and UL. At any point in time, a TID is always mapped to at least one setup link both in DL and UL, which means that a TID-to-link mapping change can only be valid and successful if it does not result in a TID having a mapped link set made of zero setup links.

By default, all setup links are enabled. If a link is enabled for a non-AP MLD, it may be used for the exchange of individually addressed frames, subject to the power state of the non-AP STA operating on that link. Only MSDUs or A-MSDUs with TIDs mapped to a link may be transmitted on that link in the direction (DL/UL) corresponding to the TID-to-link mapping. Individually addressed management frames and control frames may be sent on any enabled link between an affiliated STA of the non-AP MLD and a corresponding AP of the AP MLD, both in DL and UL.

If a link is disabled for a non-AP MLD, the link may not be used for the exchange of individually addressed frames between an affiliated STA of the non-AP MLD and a corresponding AP of the AP MLD.

If a TID is mapped in UL to a set of enabled links for a non-AP MLD, the non-AP MLD may use any link within this set of enabled links to transmit individually addressed MSDUs or A-MSDUs corresponding to that TID.

If a TID is mapped in DL to a set of enabled links for a non-AP MLD, the non-AP MLD may retrieve individually addressed BUs buffered at the AP MLD that are MSDUs or A-MSDUs corresponding to the TID, on any link of the set of enabled links. Conversely, the AP MLD may use any link within the set of enabled links to transmit individually addressed MSDUs or A-MSDUs corresponding to the TID, subject to the power state of the non-AP STA on each of the used links.

If the default mode is used, the non-AP MLD may retrieve BUs buffered by the AP MLD on any setup link, though the AP MLD may recommend a link.

A non-AP MLD may retrieve buffered BUs that are MMPDUs buffered at the AP MLD on any enabled link. An AP MLD may use any enabled link to transmit individually addressed bufferable management frames that are not measurement MMPDUs, subject to the power state of the non-AP STA on the used link.

If a STA affiliated with a non-AP MLD is in active mode on a link with a set of TIDs mapped for DL transmission, its associated AP affiliated with the AP MLD may transmit to the STA: MSDUs/A-MSDUs for the set of mapped TIDs for the non-AP MLD; and MMPDUs that are not measurement MMPDUs for the non-AP MLD or its affiliated STAs, unless the frames are transmitted to another STA affiliated with the same non-AP MLD and in active mode.

As mentioned above, under the default mapping mode, all TIDs are mapped to all setup links for DL and UL, and all setup links are enabled. A non-AP MLD and an AP MLD that perform multi-link setup shall operate under this mode if a TID-to-link mapping negotiation for a different mapping has not occurred, was unsuccessful, or was torn down.

In a multi-link (re)setup procedure, a non-AP MLD may initiate a TID-to-link mapping negotiation by including a TID-to-link mapping element in a (re)association request frame if an AP MLD has indicated support for TID-to-link mapping negotiation.

After receiving the (re)association request frame containing the TID-to-link mapping element, the AP MLD may reply to the (re)association request frame according to the following rules. The AP MLD can accept the requested TID-to-link mapping indicated in the TID-to-link mapping element in the received (re)association request frame only if it accepts the multi-link (re)setup for all links on which at least one TID is requested to be mapped. In this case, the non-AP MLD does include in the (re)association response frame a TID-to-link mapping element. Otherwise, the non-AP MLD indicates rejection of the proposed TID-to-link mapping by including in the (re)association response frame a TID-to-link mapping element that suggests a preferred TID-to-link mapping.

Following a successful multi-link (re)setup, to negotiate a new TID-to-link mapping, an initiating MLD may send an individually addressed TID-to-link mapping request frame to a responding MLD that has indicated support of TID-to-link mapping negotiation.

On receiving the individually addressed TID-to-link mapping request frame, the responding MLD sends an individually addressed TID-to-link mapping response frame to the initiating MLD according to the following rules. The responding MLD may accept the requested TID-to-link mapping indicated in the TID-to-link mapping element in the received TID-to-link mapping request frame by transmitting a TID-to-link mapping response frame. Otherwise, the responding MLD may indicate rejection of the proposed TID-to-link mapping in the TID-to-link mapping response frame. The responding MLD may suggest a preferred TID-to-link mapping in the TID-to-link mapping response frame by including the TID-to-link mapping element in the TID-to-link mapping response frame.

An MLD may suggest a preferred TID-to-link mapping to a peer MLD by sending an unsolicited TID-to-link mapping response frame that includes a TID-to-link mapping element.

When a peer MLD indicates a preferred TID-to-link mapping, an MLD may take into account the preferred TID-to-link mapping when it initiates a new TID-to-link mapping. In addition, an AP MLD may take into account the traffic flow(s) affiliated with the non-AP MLD and the capabilities and constraints (if any) of the non-AP MLD.

When two MLDs have negotiated a TID-to-link mapping, either MLD may tear down the negotiated TID-to-link mapping by sending an individually addressed TID-to-link mapping teardown frame. After teardown, the MLDs operates in default mapping mode.

When an MLD successfully negotiates a TID-to-link mapping with a peer MLD, both the MLD and the peer MLD update an uplink and/or downlink TID-to-link mapping information according to the negotiated the TID-to-link mapping.

When an MLD has successfully negotiated with a peer MLD an uplink and/or downlink TID-to-link mapping in which the bit position i of a link mapping field n in the TID-to-link mapping element is set to 0, a TID n shall not be mapped to the link associated with the link ID i in uplink and/or downlink. When an MLD has successfully negotiated with a peer MLD an uplink and/or downlink TID-to-link mapping in which the bit position i of a link mapping field n in the TID-to-link mapping element is set to 1, the TID n is mapped to the link associated with the link ID i in uplink and/or downlink.

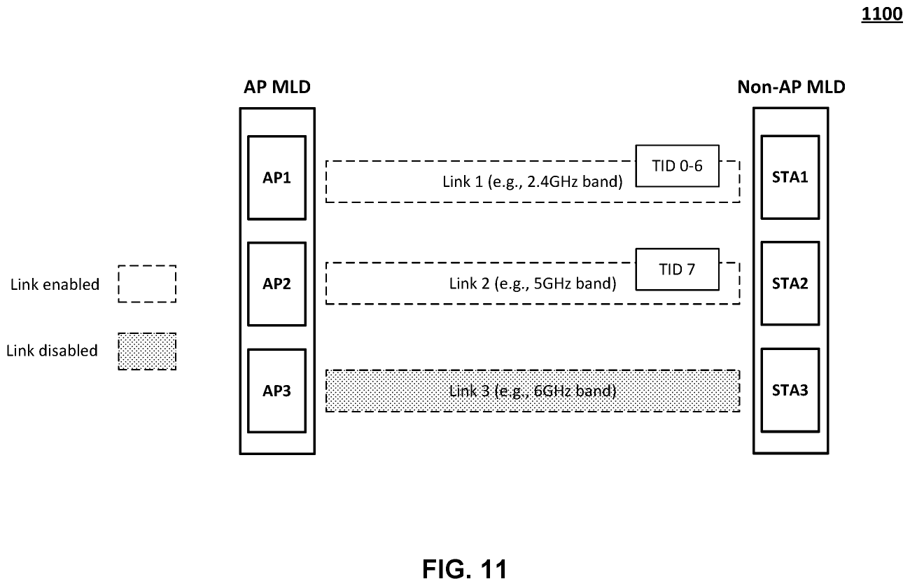

FIG. 11 illustrates an example of a TID-to-link mapping in a multi-link communication environment. As shown, the multi-link communication environment includes an AP MLD having three affiliated APs and a non-AP MLD having three affiliated STAs.

During or after multi-link setup, the non-AP MLD and the AP MLD may negotiate a TID-to-link mapping. The TID-to-link mapping maps TIDs at the non-AP MLD in UL and DL to setup links between the AP MLD and the non-AP MLD. For example, as shown in FIG. 11, the TID-to-link mapping may map TIDs 0-6 in both UL and DL to link 1 and TID 7 in both UL and DL to link 2. As such, links 1 and 2 are enabled, and link 3 is disabled. The TID-to-link mapping negotiation may be performed by exchanging an association request/response frame or a TID-to-link mapping request/response frame between the non-AP MLD and the AP MLD.

An AP MLD may advertise a mandatory TID-to-link mapping by including a TID-To-Link Mapping element in the Beacon and Probe Response frames that the APs affiliated with the AP MLD transmit.

An AP affiliated with an AP MLD may schedule for transmission a Link Recommendation frame to provide link recommendation for a set of non-AP MLDs.

An AP MLD shall use the procedures of advertised TID-to-link mapping in Beacon and Probe Response frames in order to disable or enable a link for all associated non-AP MLDs.

A non-simultaneous transmit and receive (NSTR) mobile AP MLD is a mobile AP MLD with at least one NSTR link pair. A NSTR link pair is a pair of links corresponding to STAs affiliated with an MLD for which receiver requirements are not met on one of the links when a STA affiliated with the MLD is transmitting on the other link. Each link of such a pair is a member of the NSTR link pair. For example, if an MLD supports transmission on link 1 concurrently with reception on link 2, but cannot support transmission on link 2 concurrently with reception on link 1, then link 1 and link 2 are an NSTR link pair for that MLD.

A simultaneous transmit and receive (STR) link pair is a pair of links that is not an NSTR link pair. When a pair of links on which an MLD operates is an STR link pair, a STA that is affiliated with the MLD and that is operating on a first link in the STR link pair shall access the wireless medium on the first link by following the rules for EDCA regardless of any activity occurring on a second link of the STR link pair, unless explicitly stated otherwise.

All pairs of links for an AP MLD that is not an NSTR mobile AP MLD and that operates on more than one link shall be STR link pairs. If an AP MLD that is not an NSTR mobile AP MLD operates on only one link, any STR requirements and capabilities that correspond to a link pair no longer apply.

An AP affiliated with an AP MLD that has gained the right to initiate transmission of a frame of an AC on a link through the rules for EDCA may choose not to transmit any frame corresponding to that AC due to expected interference caused by the transmission at the STA operating on the other link of an NSTR link pair that the link belongs to within the intended recipient non-AP MLD and due to lack of availability of an alternative frame in the queue that would not introduce the opportunity for such interference.

A non-AP STA affiliated with a non-AP MLD operating on a link of an NSTR link pair that has gained the right to initiate transmission of a frame of an AC on a link through the rules for EDCA backoff or that is enabled by an AP that is the TXOP holder to use a portion of the obtained TXOP through the rules for Triggered TXOP sharing may choose not to transmit any frame corresponding to that AC due to expected interference caused by the transmission at the non-AP STA operating on the other link of the NSTR link pair within the non-AP MLD and due to lack of availability of an alternative frame in the queue that would not introduce the opportunity for such interference.

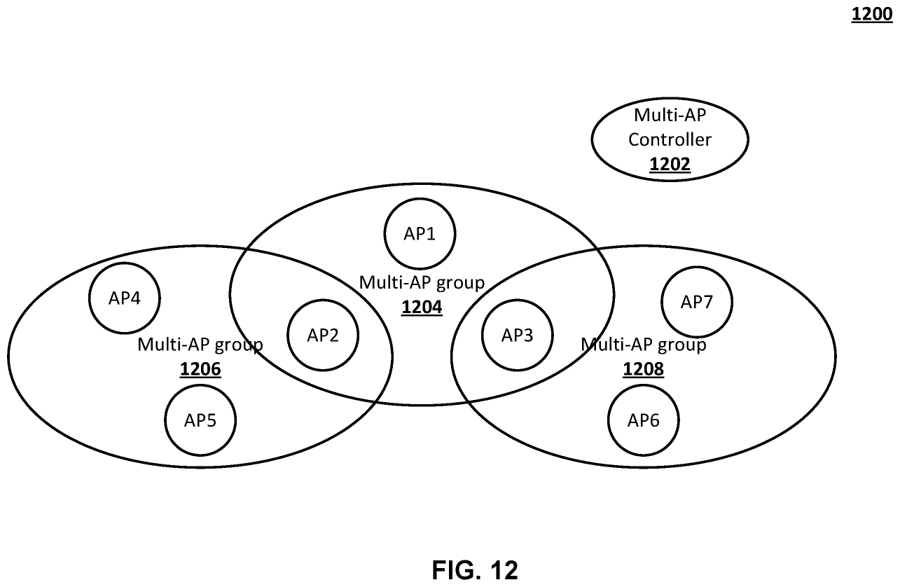

FIG. 12 illustrates an example multi-AP network 1200. Example multi-AP network 1200 may be a multi-AP network in accordance with the Wi-Fi Alliance standard specification for multi-AP networks. As shown in FIG. 12, multi-AP network 1200 may include a multi-AP controller 1202 and a plurality of multi-AP groups (or multi-AP sets, or AP candidate sets), including multi-AP group 1204, multi-AP group 1206, and multi-AP group 1208.

Multi-AP controller 1202 may be a logical entity that implements logic for controlling the APs in multi-AP network 1200. Multi-AP controller 1202 may receive capability information and measurements from the APs and may trigger AP control commands and operations on the APs. Multi-AP controller 1202 may also provide onboarding functionality to onboard and provision APs onto multi-AP network 1200.

Multi-AP group 1204, multi-AP group 1206, and multi-AP group 1208 may each include a plurality of APs. APs in a multi-AP group are in communication range of each other. However, the APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, one of the APs in a multi-AP group may be designated as a master AP. The designation of the master AP may be done by multi-AP controller 1202 or by the APs of the multi-AP group. The master AP of a multi-AP group may be fixed or may change over time between the APs of the multi-AP group. An AP that is not the master AP of the multi-AP group is known as a slave AP.

In one approach, a multi-AP group or an AP candidate set is a set of APs that can initiate or participate in multi-AP coordination. An AP in a multi-AP group can participate as a slave AP in multi-AP coordination initiated by a master AP in the same multi-AP group. At least one AP in a multi-AP group shall be capable of being a master AP.

In one approach, APs in a multi-AP group may coordinate with each other, including coordinating transmissions within the multi-AP group. One aspect of coordination may include coordination to perform multi-AP transmissions within the multi-AP group. As used herein, a multi-AP transmission is a transmission event in which multiple APs (of a multi-AP group or a multi-AP network) transmit simultaneously over a period. The period of simultaneous AP transmission may be a continuous period.

Multi-AP group coordination may be enabled by the multi-AP controller and/or by the master AP of the multi-AP group. In one approach, the multi-AP controller and/or the master AP may control time and/or frequency sharing in a TXOP. For example, when one of the APs (e.g., the master AP) in the multi-AP group obtains a TXOP, the multi-AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Multi-AP operation may be enabled by at least two APs that support multi-AP coordination within one or more multi-AP groups. The APs may support multi-AP transmission schemes in a multi-AP network. A master AP may coordinate with slave AP(s) to enable multi-AP coordination and to support a multi-AP transmission. Slave AP(s) may participate in a multi-AP transmission. The master AP may select the slave AP(s) which are suitable for the multi-AP transmission. Slave APs may be candidates for a multi-AP transmission before being designated by the master AP.

Multi-AP transmission schemes may include transmission schemes such as coordinated OFDMA, coordinated time division multiple access (TDMA), coordinated spatial reuse, coordinated beamforming, joint transmission or reception (JT/JR), or a combination of two or more of the aforementioned schemes.

Coordinated OFDMA and coordinated TDMA may be categorized as coordinated TXOP, in which frequency or time resources of a TXOP may be used to coordinate the interference. Coordinated spatial reuse (CSR) may provide reuse of spatial domain of neighboring BSSs by adjusting the transmit powers of coordinated APs. Coordinated beamforming (CBF) may provide dedicated null steering with spatial radiation based on channel state information (CSI) feedback from coordinated APs with the aid of multiple antennas to suppress the interference. JT/JR may use distributed MIMO precoding or detection, via shared CSI, for data streams among multiple APs.

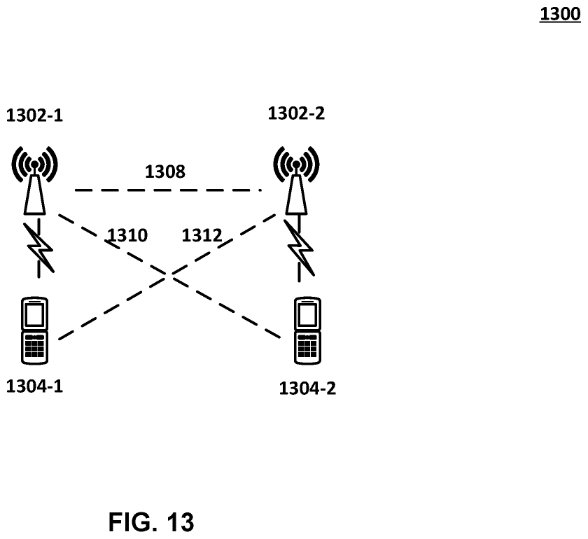

FIG. 13 illustrates an example network 1300 that includes a coordinated AP set. As shown in FIG. 13, the coordinated AP set may include AP 1302-1 and AP 1302-2. The coordinated AP set may be a subset of an established multi-AP group. At least one STA may be associated with each of APs 1302-1 and 1302-2. For example, a STA 1304-1 may be associated with AP 1302-1, and a STA 1304-2 may be associated with AP 1302-2.

APs 1302-1 and 1302-2 may belong to the same ESS as described above in FIG. 1. In such a case, APs 1302-1 and 1302-2 may be connected by a DS to support ESS features. In addition, as part of a coordinated AP set, APs 1302-1 and 1302-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 1302-1 and 1302-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Depending on the capability of APs in a coordinated AP set, the APs may only do certain type of coordinated transmissions. For example, in FIG. 13, if AP 1302-1 supports JT and CSR while AP 1302-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 1301-1 and AP 1302-2 as shown in FIG. 13. Spatial reuse using CSR can be more stable than non-AP coordinated spatial reuse schemes such as overlapping basic service set (OBSS) packet detect (PD)-based SR and PSR-based SR. For example, in example network 1300, APs 1302-1 and 1302-2 may perform a joint sounding operation in order to measure path loss (PL) on paths of network 1300. For example, the joint sounding operation may result in the measurement of PL 1308 for the path between APs 1302-1 and 1302-2, path loss 1310 for the path between AP 1302-1 and STA 1304-2, and path loss 1312 for the path between AP 1302-2 and STA 1304-1. The measured path loss information may then be shared between APs 1302-1 and 1302-2 (e.g., using the backhaul) to allow for simultaneous transmissions by APs 1302-1 and 1302-2 to their associated STAs 1304-1 and 1304-2 respectively. Specifically, one of APs 1302-1 and 1302-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

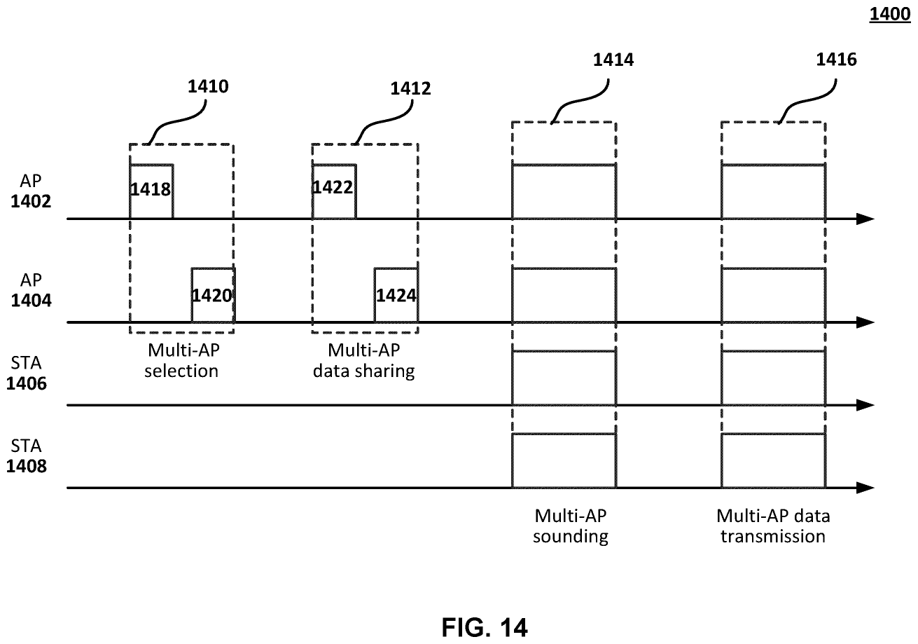

FIG. 14 illustrates an example 1400 of a multi-AP operation procedure. In example 1400, the multi-AP operation procedure is illustrated with respect to a multi-AP network that includes APs 1402 and 1404 and STAs 1406 and 1408. In an example, APs 1402 and 1404 may form a multi-AP group. AP 1402 may be the master AP and AP 1404 may be a slave AP of the multi-AP group. For example, AP 1402 may obtain a TXOP making it the master AP of the multi-AP group. Alternatively, AP 1402 may be designated as the master AP by a multi-AP controller.

As shown in FIG. 14, the multi-AP operation procedure may include a series of phases in time, each of which may contain a plurality of frame exchanges within the multi-AP network. Specifically, the multi-AP operation procedure may include a multi-AP selection phase 1410, a multi-AP data sharing phase 1412, a multi-AP sounding phase 1414, and a multi-AP data transmission phase 1416.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 1410 may include procedures for soliciting, selecting, or designating slave AP(s) for a multi-AP group by a master AP. As seen in FIG. 14, the multi-AP selection phase may include transmissions of frame 618 from AP 1402 and frame 1420 from AP 1404. AP 1402 may transmit frame 1418 to solicit information regarding the buffer status of AP 1404. In response, AP 1404 may transmit frame 1420 to inform AP 1402 of its and its associated STAs buffer status and/or whether it intends to join multi-AP operation. Multi-AP selection phase 1410 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 1412 may include procedures for sharing data frames to be transmitted by APs to associated STAs among the master AP and selected slave AP(s) via direct connections between APs. Phase 1412 may be optional for some multi-AP data transmission schemes. For example, phase 1412 may be required for JT/JR as data frames may be exchanged between APs before or after multi-AP data transmission phase 1416.

Multi-AP data sharing phase 1412 may be performed using a wired backhaul, an in-channel wireless backhaul, or an off-channel wireless backhaul. In some cases, multi-AP data sharing phase 1412 may be performed over an in-channel backhaul, e.g., using the same wireless channel used to transmit/receive data to/from STAs. For example, as shown in FIG. 14, in phase 1412, AP 1402 may transmit a frame 1422, which may be received by AP 1404. Frame 1422 may include MPDUs that AP 1402 wishes to transmit to associated STAs using a multi-AP operation. Similarly, AP 1404 may transmit a frame 1424, which may be received by AP 1402. Frame 1424 may include MPDUs that AP 1404 wishes to transmit to associated STAs using a multi-AP operation.

Multi-AP sounding phase 1414 may include procedures for multi-AP channel sounding, including channel estimation and feedback of channel estimates among the master AP, candidate slave AP(s), and associated STAs. Phase 1414 may be optional for some multi-AP transmission schemes, such as COFDMA, CDTMA, and CSR. For example, phase 1414 may be performed by the master AP to aid in resource unit allocation when orchestrating a COFDMA transmission.

Multi-AP data transmission phase 1416 may include exchange of data frames between the master AP, slave AP(s), and their associated STAs based on multi-AP transmission scheme(s) determined by the master AP. Depending on the multi-AP transmission scheme(s) to be used, phase 1416 may include optional synchronization between APs of the multi-AP group, before exchange of data frames between APs and STAs within the multi-AP group.

The order of phases 1410, 1412, 1414 and 1416 may be different than shown in FIG. 14. For example, in COFDMA, phase 1416 may occur immediately after phase 1410, whereas, in JT/JR, phase 1412 may occur after phase 1410. Further, as mentioned above, some phases may be optional and may or may not be present. For example, phase 1414 may not be required for COFDMA but may be required for JT/JR.

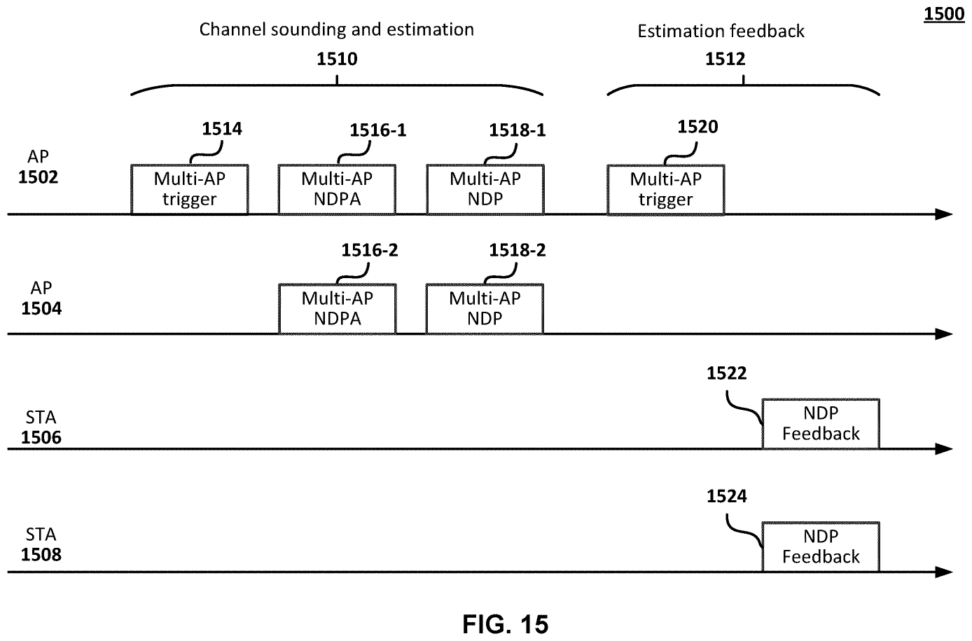

FIG. 15 illustrates an example 1500 of a multi-AP sounding phase. Multi-AP sounding phase 1500 may be an example of multi-AP sounding phase 1414. As shown in FIG. 15, example 1500 may include a master AP 1502 and a slave AP 1504 of a multi-AP group. Example 1500 may further include a STA 1506 associated with AP 702 and a STA 1508 associated with AP 1504.

As shown in FIG. 15, multi-AP sounding phase 1500 may include frame exchanges to allow AP 1502 (the master AP) to acquire channel state information (CSI) of channels in the multi-AP group. In an implementation, phase 1500 may include a first subphase 1510 and a second subphase 1512. During the first subphase 1510, APs may initiate channel sounding and STAs may estimate CSI. For example, AP 1502 may transmit a frame 1514 to AP 1504 (the slave AP) to trigger multi-AP sounding. Frame 1514 may comprise a multi-AP trigger frame. Subsequently, APs 1502 and 1504 may transmit respectively announcement frames 1516-1 and 1516-2 to their respective associated STAs 1506 and 1508 to announce the transmission of sounding frames. Frames 1516-1 and 1516-2 may comprise multi-AP null data packet announcement (NDPA) frames. Frames 1516-1 and 1516-2 may be transmitted simultaneously. Next, APs 1502 and 1504 may transmit respectively frames 1518-1 and 1518-2 to STAs 1506 and 1508, respectively. Frames 1518-1 and 1518-2 may comprise multi-AP null data packet (NDP) frames. STAs 1506 and 1508 receive frames 1518-1 and 1518-2 respectively and perform channel estimation of the channels from AP 1502 to STA 1506 and from AP 1504 to STA 1508, respectively.

During the second subphase 1512, APs may initiate a procedure for STAs to feed back channel estimates to the APs. For example, AP 1502 may transmit a frame 1520 to trigger STAs 1506 and 1508 to transmit their channel estimates to APs 1502 and 1504, respectively. Frame 1520 may comprise a multi-AP trigger frame. In response, STAs 1506 and 1508 may transmit respectively frames 1522 and 1524 including feedback of channel estimates to APs 1502 and 1504, respectively. Frames 1522 and 1524 may comprise NDP feedback frames. The feedback of channel estimates may include NDP feedback, CSI-related information, a beamforming report (BFR), or a channel quality indication (CQI) report.

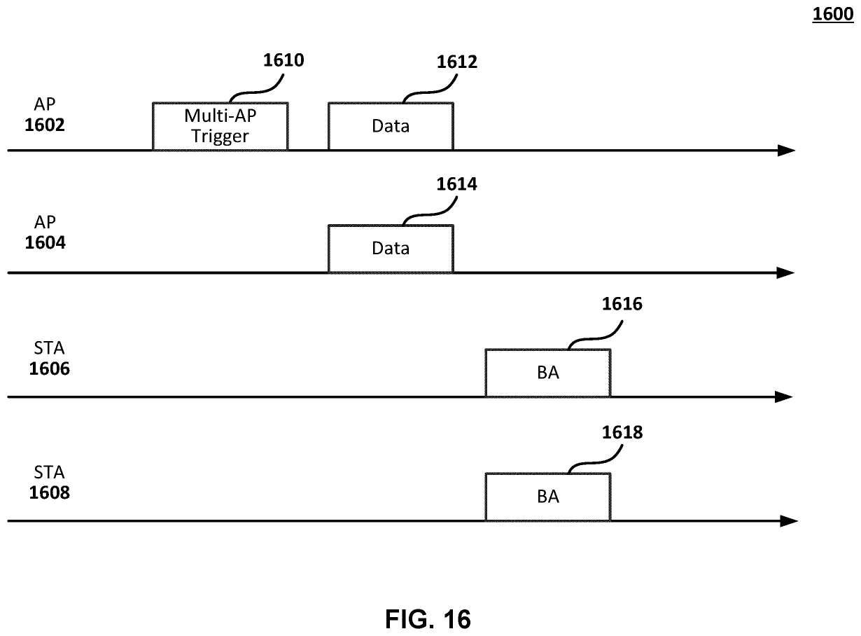

FIG. 16 illustrates an example 1600 of a multi-AP downlink data transmission phase. Multi-AP downlink data transmission phase 1600 may be an example of multi-AP data transmission phase 1516. As shown in FIG. 16, example 1600 may include a master AP 1602 and a slave AP 1604 of a multi-AP group. Example 1600 may further include a STA 1606 associated with AP 1602, and a STA 1608 associated with AP 1604.

As shown in FIG. 16, multi-AP downlink data transmission phase 1600 may include frame exchanges to enable master AP 1602 to coordinate with slave AP 1604 to perform specific multi-AP transmission schemes with their associated STAs 1606 and 1608, respectively. The multi-AP transmission schemes may include COFDMA, CTDMA, CSR, CBF, JT/JR, or a combination of two or more of the aforementioned schemes.

As shown in FIG. 16, master AP 1602 may begin phase 1600 by transmitting a frame 1610 to AP 1604. Frame 1610 may include information related to AP 1604 (e.g., an identifier of AP 1604), synchronization information, information related to a specific multi-AP transmission scheme to be used, and/or information related to a resource unit (RU) for use by AP 1604 to acknowledge frame 1610. Frame 1610 may comprise a control frame. For example, frame 1610 may comprise a multi-AP trigger frame.

Slave AP 1604 may receive frame 1610 and may use the synchronization information to synchronize with master AP 1602. Subsequently, APs 1602 and 1604 may perform data transmission to their associated STAs 1606 and 1608, respectively. Specifically, AP 1602 may transmit a data frame 1612 to its associated STA 1606, and AP 1604 may transmit a data frame 1614 to its associated STA 1608. Depending on the multi-AP transmission scheme being used, APs 1602 and 1604 may transmit frames 1612 and 1614 respectively to STAs in different BSSs. For example, when the multi-AP transmission scheme is JT/JR, AP 1602 may also transmit frame 1612 to STA 1608 associated with slave AP 1604, and AP 1604 may also transmit frame 1614 to STA 1608 associated with AP 1604. The resources for transmitting and receiving frames 1612 and 1614 may depend on the specific multi-AP transmission scheme adopted.

STAs 1606 and 1608 may acknowledge frames 1612 and 1614, respectively. For example, STA 1606 may transmit a frame 1616 to AP 1602, and STA 1608 may transmit a frame 1618 to AP 1604. Frames 1616 and 1618 may comprise block ack (BA) frames. STAs 1606 and 1608 may also transmit frames 1616 and 1618 to APs in different BSSs, when required by the used multi-AP transmission scheme. For example, when the multi-AP transmission scheme is JT/JR, STA 1606 may also transmit frame 1616 to AP 1604, and STA 1608 may also transmit frame 1618 to AP 1602. The resources for transmitting and receiving frames 1616 and 1618 may depend on the specific multi-AP transmission scheme adopted.

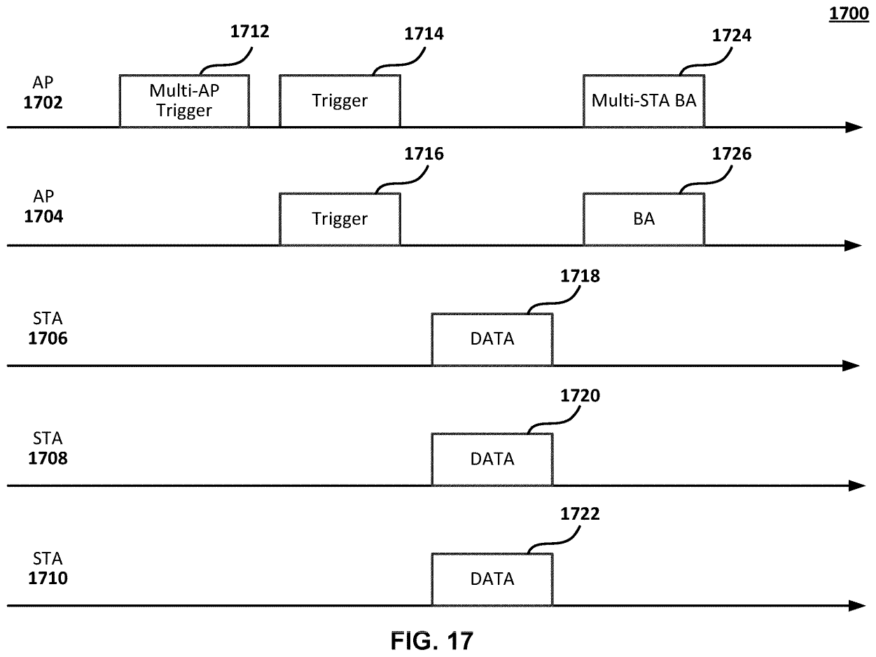

FIG. 17 illustrates an example 1700 of a multi-AP uplink data transmission phase. Multi-AP uplink data transmission phase 1700 may be an example of multi-AP data transmission phase 1516. As shown in FIG. 17, example 1700 may include a master AP 1702 and a slave AP 1704 of a multi-AP group. Example 1700 may further include STAs 1706 and 1708 associated with AP 1702, and a STA 1710 associated with AP 1704.

As shown in FIG. 17, multi-AP uplink data transmission phase 1700 may include frame exchanges to enable master AP 1702 to coordinate with slave AP 1704 to perform specific multi-AP transmission schemes with STAs 1706, 1708, and 1710. The multi-AP transmission schemes may include COFDMA, CTDMA, CSR, CBF, JT/JR, or a combination of two or more of the aforementioned schemes.

As shown in FIG. 17, master AP 1702 may begin phase 1700 by transmitting a frame 1712 to AP 1704. Frame 1712 may include information related to AP 1704 (e.g., an identifier of AP 1704), synchronization information, information related to a specific multi-AP transmission scheme to be used, and/or information related to an RU for use by AP 1704 to acknowledge frame 1712. Frame 1712 may comprise a control frame. For example, frame 1712 may comprise a multi-AP trigger frame.

Slave AP 1704 may receive frame 1712 and may use the synchronization information to synchronize with master AP 1702. Subsequently, APs 1702 and 1704 may solicit uplink data transmissions from their associated STAs 1706, 1708 and 1710 using trigger frames. Specifically, AP 1702 may transmit a trigger frame 1714 to its associated STAs 1706 and 1708, and AP 1704 may transmit a trigger frame 1716 to its associated STA 1710. Depending on the multi-AP transmission scheme being used, APs 1702 and 1704 may also transmit frames 1714 and 1716 respectively to STAs in different BSSs. For example, when the multi-AP transmission scheme is JT/JR, AP 1702 may also transmit frame 1714 to STA 1710 associated with slave AP 1704, and AP 1704 may also transmit frame 1716 to STAs 1706 and 1708 associated with AP 1702. The resources for transmitting and receiving frames 1714 and 1716 may depend on the specific multi-AP transmission scheme adopted.

STAs 1706 and 1708 may respond to frame 1714, STA 1710 may respond to frame 1716. For example, STAs 1706 and 1708 may transmit frames 1718 and 1720 respectively to AP 1702, while STA 1710 may transmit a frame 1722 to AP 1704. Frames 1718, 1720, and/or 1722 may be transmitted simultaneously. Frames 1718, 1720, and 1722 may comprise data frames or null data frames. STAs 1706, 1708, and 1710 may also transmit frames 1718, 1720, and 1722 respectively to APs in different BSSs, when required by the used multi-AP transmission scheme. For example, when the multi-AP transmission scheme is JT/JR, STAs 1706 and 1708 may also transmit respective frames 1718 and 1720 to AP 1704, and STA 1710 may also transmit frame 1722 to AP 1702. The resources for transmitting and receiving frames 1718, 1720, and 1722 may depend on the specific multi-AP transmission scheme adopted.

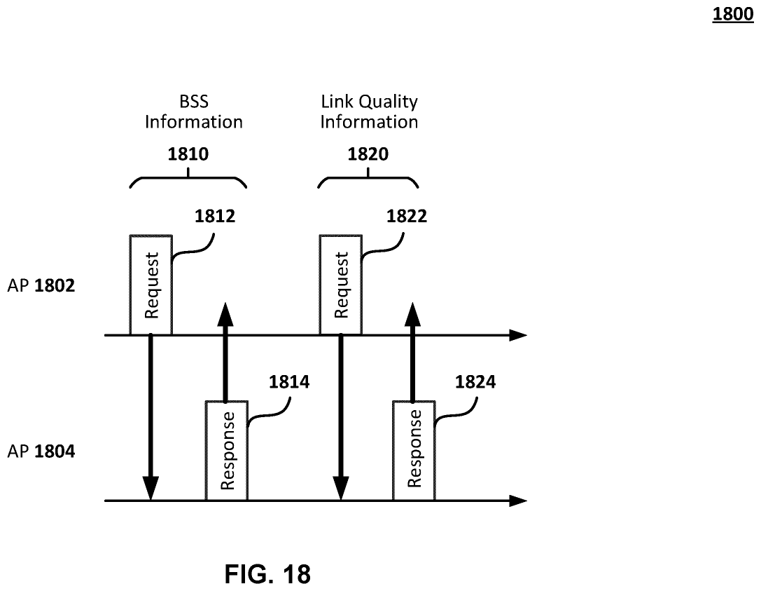

FIG. 18 illustrates an example 1800 of a multi-AP information exchange phase. Multi-AP information exchange phase 1800 may be an example of multi-AP information exchange phase 946. As shown in FIG. 18, example 1800 may include a master AP 1802 and a slave AP 1812 of a multi-AP group. In an example, AP 1802 and AP 1812 may have exchanged beacon frames in a prior phase (e.g., multi-AP setup phase 940). AP 1812 may be a candidate slave AP when phase 1800 occurs during a multi-AP setup phase or before AP 1812 is selected or designated as a slave AP in a subsequent multi-AP selection phase (e.g., multi-AP selection phase 950). By contrast, AP 1812 may be a designated slave AP when phase 1800 occurs (or repeats) after AP 1812 is selected or designated as a slave AP in a multi-AP selection phase.

As shown in FIG. 18, phase 1800 may include subphases 1840 and 1850. In an example, during subphase 1840, AP 1802 may send a frame 1842 to AP 1812 to request BSS information from AP2. Frame 1842 may be a BSS information request frame. In response, AP 1812 may send to AP 1802 a frame 1844 including the BSS information of AP 1812. Frame 1844 may be a BSS information response frame.

In an example, during subphase 1850, AP 1802 may send a further frame 1852 to AP 1812 to request link quality information from AP 1812. In response, AP 1812 may send to AP 1802 a frame 1854 including the requested link quality information. Frame 1852 may be a link quality information response frame.

Target wake time (TWT), a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

A TWT session may be negotiated between an AP and a STA. The TWT session may configure a TWT service period (SP) of downlink (DL) and UL traffic between the AP and the STA. Expected traffic may be limited within the negotiated SP. The TWT SP may start at a specific time. The TWT SP may run for a SP duration. The TWT SP may repeat every SP interval.

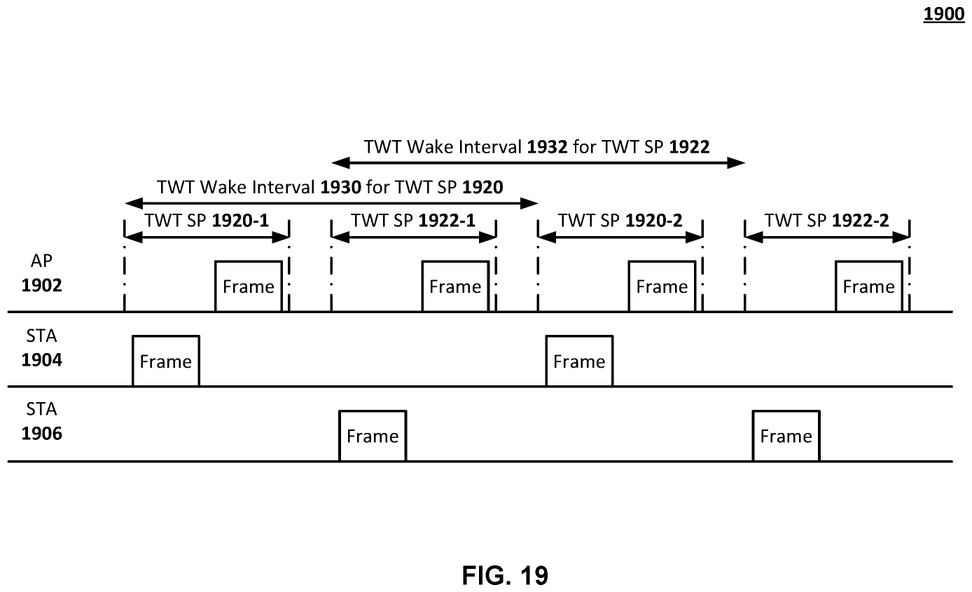

FIG. 19 illustrates an example TWT operation 1900. TWT operation 1900 includes an AP 1902, a STA 1904, and a STA 1906. AP 1902 and STA 1904 may establish a TWT SP 1920. AP 1902 and STA 1906 may establish a TWT SP 1922. TWT SP 1920 and TWT SP 1922 may repeat as shown in FIG. 10, such that TWT SP 1920 may include a first TWT SP 1920-1 and a second TWT SP 1920-2, and such that TWT SP 1922 may include a first TWT SP 1922-1 and a second TWT SP 1922-2.

AP 1902 and STA 1904 may exchange frames during first TWT SP 1920-1. STA 1904 may enter a doze state at the end of TWT SP 1920-1 and may remain in the doze state until the start of second TWT SP 1920-2. The start of second TWT SP 1920-2 may be indicated by a TWT wake interval 1930 associated with TWT SP 1920. AP 1902 and STA 1904 may again exchange frames during second TWT SP 1920-2.

Similarly, A P 1902 and STA 1906 may exchange frames during first TWT SP 1922-1. STA 1906 may enter a doze state at the end of first TWT SP 1922-1 and may remain in the doze state until the start of second TWT SP 1922-2. The start of second TWT SP 1922-2 may be indicated by a TWT wake interval 1932 associated with TWT SP 1922. AP 1902 and STA 1906 may again exchange frames during second TWT SP 1922-2.

In an awake state, a STA may be fully powered. The STA may transmit and/or receive a frame to/from an AP or another STA. In a doze state, a STA may not transmit and may not receive a frame to/from an AP or another STA.

Restricted TWT (R-TWT) operation enables the STAs in a BSS to use enhanced medium access protection and resource reservation mechanisms for delivery of latency sensitive traffic.

An R-TWT membership is established using the same procedure used to set up a broadcast TWT membership except that the broadcast TWT element(s) carried in the TWT Setup frame include one or more Restricted TWT Parameter Set fields.

The R-TWT scheduling AP and the R-TWT scheduled STA should set the Restricted TWT Traffic Info field to identify the TID(s) that carry latency sensitive traffic in DL and UL for the R-TWT membership being set up.

The TID(s) indicated as latency sensitive traffic in DL and UL in the Restricted TWT Traffic Info field shall be within the set of TIDs that are mapped in DL and UL, respectively, to the link on which the R-TWT membership is being setup. The TID(s) that are specified in the Restricted TWT Traffic Info field of the TWT element in a TWT response that indicates Accept TWT are referred to as R-TWT DL TID(s) or R-TWT UL TID(s), and collectively as R-TWT TID(s).

When a TID-to-link mapping update results in a mapping where none of the R-TWT TID(s) for an R-TWT membership are mapped onto the link on which the R-TWT membership is set up, the corresponding R-TWT membership is considered as torn down.

An R-TWT scheduled STA may signal a QoS Characteristics element for a traffic flow intended to be delivered during R-TWT SPs of an R-TWT schedule in an (stream classification service) SCS Request frame to the R-TWT scheduling AP as per procedures.

If an R-TWT scheduling AP has received QoS Characteristics element(s) from an R-TWT scheduled STA whose TID and Direction fields match an R-TWT TID and its specified direction for an R-TWT membership setup, the R-TWT scheduling AP may use those parameters in QoS Characteristics element(s) as guidance for R-TWT membership setup.

The stream classification service (SCS) is a service that may be provided by an AP to its associated STAs that support SCS. In SCS, the AP classifies incoming individually addressed MSDUs based upon parameters provided by the non-AP STA.

The SCS procedure is used by a non-AP MLD to request an AP MLD to classify incoming individually addressed MSDUs based on parameters provided by the non-AP MLD and/or describe its traffic characteristics to an AP MLD.

An EHT STA establishes SCS stream with an EHT AP, as defined in SCS procedures.

A non-AP EHT STA may transmit an SCS Request frame with SCS Descriptor element(s) containing a QoS Characteristics element if the Request Type field in the frame is set to “Add” or “Change”. The QoS Characteristics element describes the traffic characteristics of the requested SCS stream. A non-AP EHT STA shall not transmit an SCS Request frame with SCS Descriptor element(s) containing a QoS Characteristics element to an AP from which it has not received an EHT Capabilities element with the SCS Traffic Description Support field equal to 1.

The MLDs maintain SCSIDs at MLD level, i.e., the SCSID used by a non-AP STA affiliated with a non-AP MLD in an SCS Request frame transmitted to an AP affiliated with an AP MLD is unique across all STAs affiliated with the non-AP MLD.

All STAs affiliated with an MLD shall set the SCS field of the Extended Capabilities element that they transmit to the same value. The SCSID is used by a non-AP MLD to request creation, modification, or deletion of an SCS stream. The SCSID is used by an AP MLD to identify an SCS stream in SCS responses.

An SCS Request frame sent by a non-AP STA affiliated with a non-AP MLD to the AP of an AP MLD that contains a QoS Characteristics element in which the Direction subfield is set to uplink or downlink or one that does not contain a QoS Characteristics element is interpreted as a request for creation of an SCS stream that applies at the MLD level.

The QoS Characteristics element is a reference for the EHT AP's scheduling. An EHT AP should schedule transmission of downlink frames such that the delay bound and minimum data rate requested are met for the downlink Data frames if the Direction subfield of the QoS Characteristics element indicates downlink. An EHT AP should enable the transmission of uplink frames from the EHT STA with an interval that falls between the requested minimum and maximum service intervals and the AP should meet the minimum data rate requested if the Direction subfield of the QoS Characteristics element indicates uplink. An EHT AP should enable the transmission of direct link frames from the EHT STA to another STA on the link specified in the LinkID subfield of the Control Info field with an interval that falls between the requested minimum and maximum service intervals.

If the EHT STA is a TWT scheduled STA or TWT requesting STA and there are negotiated TWT SPs for the TID specified in the QoS Characteristics element with the EHT AP, the EHT AP should ensure that the service interval aligns with negotiated TWT wake intervals.

If the EHT STA is an R-TWT scheduled STA and there are negotiated R-TWT SPs for the TID specified in the QoS Characteristics element then the EHT AP should use these R-TWT SPs to serve traffic corresponding to the TID and specified direction in the QoS Characteristics element. If negotiated R-TWT SPs for the TID specified in the QoS Characteristics element are trigger-enabled R-TWT, then the EHT AP should ensure that the trigger frames are scheduled at the start of the R-TWT SPs.

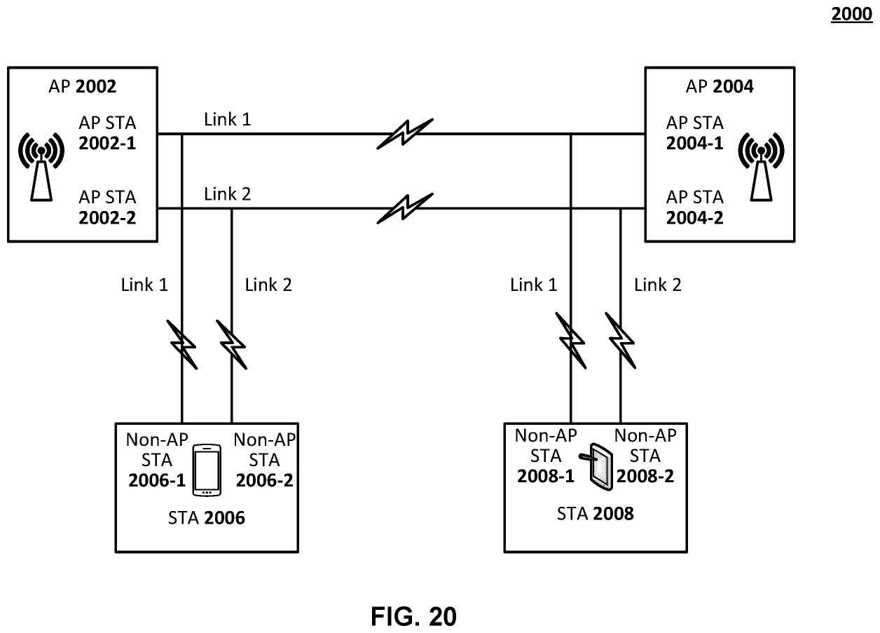

FIG. 20 illustrates an example multi-AP network 2000 supporting MLO. As shown in FIG. 20, example multi-AP network 2000 includes an AP 2002, an AP 2004, a STA 2006, and a STA 2008. APs 2002 and 2004 may form a coordinated AP set. The coordinated AP set may be a subset of an established multi-AP group. AP 2002 and/or AP 2004 may comprise an AP MLD. In an example, AP 2002 includes an affiliated AP STA 2002-1 and an affiliated AP STA 2002-2. In an example, AP 2004 includes an affiliated AP STA 2004-1 and an affiliated AP STA 2004-2.

At least one STA may be associated with each of APs 2002 and 2004. For example, STA 2006 may be associated with AP 2002, and STA 2008 may be associated with AP 2004. STA 2006 and STA 2008 may each comprise a non-AP MLD. In an example, STA 2006 includes an affiliated non-AP STA 2006-1 and an affiliated non-AP STA 2006-2. In an example, STA 2008 includes an affiliated non-AP STA 2008-1 and an affiliated non-AP STA 2008-2.

In an example, AP MLDs or non-AP MLDs are capable of communicating over multiple links, e.g., a first link and a second link. In an example, the first link may comprise one of a 2.4 GHz band, a 5 GHz band, a 6 GHz band, or a future to be defined band. Similarly, the second link may comprise one of the 2.4 GHz band, the 5 GHz band, the 6 GHz band, or a future to be defined band, with the second link being different from the first link.

In an example, AP STA 2002-1, AP STA 2004-1, non-AP STA 2006-1, and non-AP STA 2008-1 operate on the first link (link 1). In an example, non-AP STA 2006-1 is associated with AP STA 2002-1. In an example, non-AP STA 2008-1 is associated with AP STA 2004-1. In an example, AP STA 2002-2, AP STA 2004-2, non-AP STA 2006-2, and non-AP STA 2008-2 operate on the second link (link 2). In an example, non-AP STA 2006-2 is associated with AP STA 2002-2. In an example, non-AP STA 2008-2 is associated with AP STA 2008-2.

In an example, APs 2002 and 2004 may belong to the same ESS as described above in FIG. 1. In such a case, APs 2002 and 2004 may be connected by a DS to support ESS features. In addition, as part of a coordinated AP set, APs 2002 and 2004 may be connected by a backhaul. As shown in FIG. 20, example multi-AP network 2000 may use a wireless backhaul to connect AP 2002 and AP 2004, via link 1 and link 2. In an example, AP STAs 2002-1 and 2004-1 belong to different basic service sets (BSSs). In another example, AP STAs 2002-2 and 2004-2 belong to different BSSs.

It is anticipated that future IEEE 802.11 standards provide various mechanisms to support the quality of service (QoS) requirements of low latency (LL) (or latency sensitive) traffic. Such traffic may originate from various real time applications having stringent latency requirements (e.g., very low average latency, a worst-case latency of the order of a few to tens of milliseconds, and/or a small jitter). In operation, LL traffic may be associated with one or more traffic identifiers (TIDs) associated with one or more predetermined ACs or traffic streams (hereinafter TIDs associated with LL traffic are called LL TIDs). The one or more predetermined ACs may comprise the access categories for video (AC_VI) and voice (AC_VO), for example.

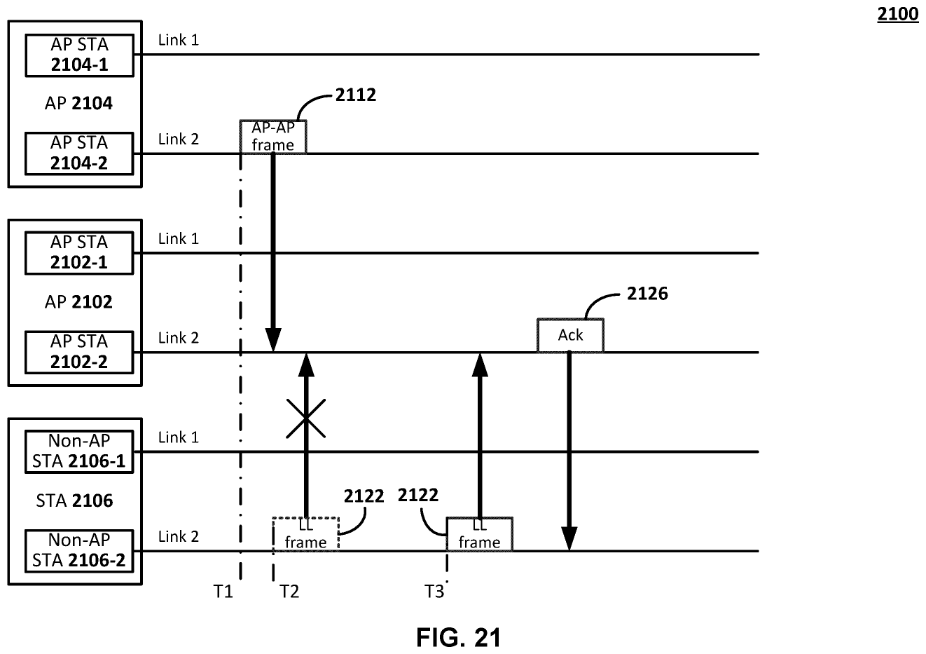

FIG. 21 illustrates an example multi-AP procedure 2100 in a multi-link environment. As shown in FIG. 21, example multi-AP procedure 2100 includes an AP 2102, an AP 2104, and a STA 2106. AP 2102 and 2104 may form a coordinated AP set. The coordinated AP set may be a subset of an established multi-AP group. AP 2102 and/or AP 2104 may comprise an AP MLD. In an example, AP 2102 includes an affiliated AP STA 2102-1 and an affiliated AP STA 2102-2. In an example, AP 2104 includes an affiliated AP STA 2104-1 and an affiliated AP STA 2104-2. As shown in FIG. 21, STA 2106 may be associated with AP 2102. STA 2106 may comprise a non-AP MLD. In an example, STA 2106 includes an affiliated non-AP STA 2106-1 and an affiliated non-AP STA 2106-2. In an example, AP STA 2102-1, AP STA 2104-1, and non-AP STA 2106-1 operate on a first link (link 1). In an example, non-AP STA 2106-1 is associated with AP STA 2102-1. In an example, AP STA 2102-2, AP STA 2104-2, and non-AP STA 2106-2 operate on a second link (link 2). In an example, non-AP STA 2106-2 is associated with AP STA 2102-2.

In an example, APs 2102 and 2104 may belong to the same ESS as described above in FIG. 1. In such a case, APs 2102 and 2104 may be connected by a DS to support ESS features. In addition, as part of a coordinated AP set, APs 2102 and 2104 may be connected by a backhaul. As shown in FIG. 21, example multi-AP procedure 2100 may use a wireless backhaul to connect AP 2102 and AP 2104, via link 1 and link 2. In an example, AP STAs 2102-1 and 2104-1 belong to different BSSs. In another example, AP STAs 2102-2 and 2104-2 belong to different BSSs.

It is assumed in example 2100 that AP 2102 and STA 2106 completed a multi-link setup. During the multi-link setup, AP 2102 may classify traffic between AP 2102 and STA 2106 into one or more categories based on latency requirements of the traffic. For example, AP 2102 may classify traffic between AP 2102 and STA 2106 into a first category and a second category. For example, the first category may comprise low latency traffic. For example, the second category may comprise non-low latency traffic. In an example, AP 2102 negotiates with STA 2106 a TID-to-link mapping to assign traffic streams to available links. In an example, AP 2102 may prioritize different links based on the category of traffic. For example, AP 2102 may prioritize link 2 over link 1 for the communication of traffic of the first category. In an example, a traffic stream of the first category between AP 2102 and STA 2106 may be mapped to link 2.

In an example, as shown in FIG. 21, AP 2104 may transmit a frame 2112 to AP 2102 via link 2 at a time T1. Frame 2112 may be an AP-to-AP frame. For example, the AP-to-AP frame may be used for multi-AP coordination between AP 2104 and AP 2102. In an example, STA 2106 may hear frame 2112 and may set its NAV based on frame 2112. Accordingly, STA 2106 may postpone transmission of a frame 2122 comprising traffic of the first category from a time T2 to a time T3 when its NAV indicates idle. When the first category comprises low latency traffic, the low latency traffic may be delayed. In another example, STA 2106 may not hear frame 2112 and may thus transmit frame 2122 to AP 2102 at the time T2. Frame 2122 may thus collide or interfere with frame 2112 at AP 2102, resulting in reception failure of one or more of the frames.

Embodiments of the present disclosure, as further described below, address the above-described problems of existing multi-AP procedures. In an embodiment, a first AP may receive from a second AP, a first frame indicating a priority of a first link, of a plurality of links, for communicating traffic of a first category via a first link by the second AP. In an embodiment, the first AP may transmit, via a second link of the plurality of links, a second frame comprising traffic of a second category, the second link selected based on the priority. As such, interference as well as latency for traffic of the first category may be reduced.

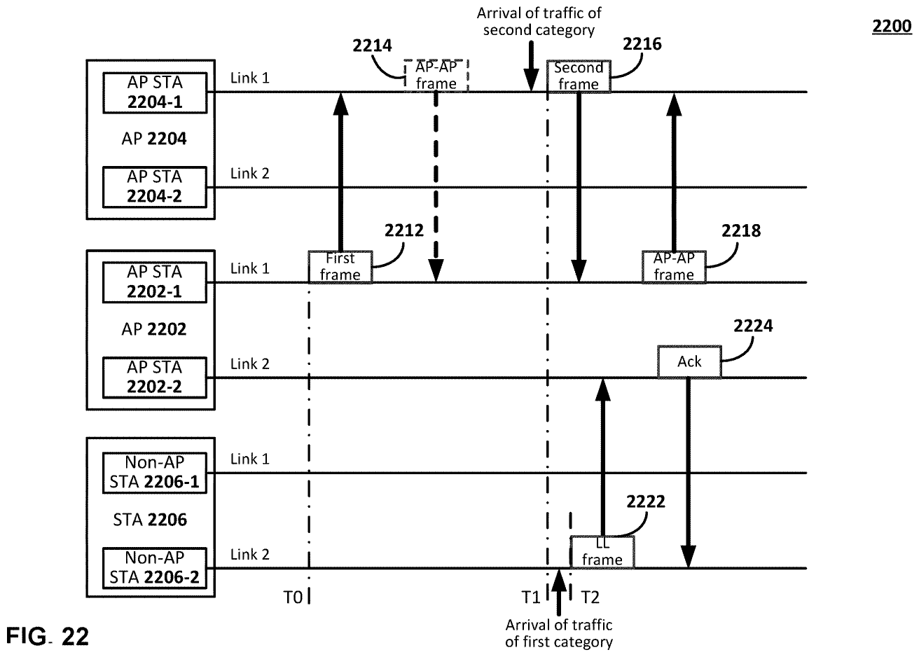

FIG. 22 illustrates an example 2200 of a multi-AP coordination procedure in a multi-link environment according to an embodiment. Example 2200 is provided for the purpose of illustration only and is not limiting. As shown in FIG. 22, example 2200 includes APs 2202 and 2204 and a STA 2206. AP 2202 and/or AP 2204 may comprise an AP MLD. STA 2206 may comprise a non-AP MLD. In an example, AP 2202 includes an affiliated AP STA 2202-1 and an affiliated AP STA 2202-2. In an example, AP 2204 includes an affiliated AP STA 2204-1 and an affiliated AP STA 2204-2. In an example, STA 2206 includes an affiliated non-AP STA 2206-1 and an affiliated non-AP STA 2206-2. In an example, AP STA 2202-1, AP STA 2204-1, and non-AP STA 2206-1 operate on a first link (link 1). In an example, the first link may comprise one of a 2.4 GHz band, a 5 GHz band, a 6 GHz band, or a future to be defined band. In an example, non-AP STA 2206-1 is associated with AP STA 2202-1. In an example, AP STA 2202-2, AP STA 2204-2, and non-AP STA 2206-2 operate on a second link (link 2). The second link may comprise one of the 2.4 GHz band, the 5 GHz band, the 6 GHz band, or a future to be defined band, with the second link being different from the first link.

In an example, APs 2202 and 2204 may belong to the same ESS. In such a case, APs 2202 and 2204 may be connected by a DS to support ESS features. In addition, as part of a coordinated AP set, APs 2202 and 2204 may be connected by a backhaul. For example, as shown in FIG. 22, APs 2202 and 2204 may be connected by a wireless backhaul comprising link 1 and link 2. In an example, non-AP STA 2206-2 is associated with AP STA 2202-2. In an example, AP STAs 2202-1 and 2204-1 belong to different BSSs. In another example, AP STAs 2202-2 and 2204-2 belong to different BSSs.

In an embodiment, AP 2202 and AP 2204 form a multi-AP group. In an example, AP STA 2202-1 and AP STA 2204-1 form a multi-AP group. In another example, AP STA 2202-2 and AP STA 2204-2 form a multi-AP group.

It is assumed in example 2200 that AP 2202 and STA 2206 completed a multi-link setup. During the multi-link setup, AP 2202 may classify traffic between AP 2202 and STA 2206 into one or more categories based on latency requirements of the traffic. For example, AP 2202 may classify traffic between AP 2202 and STA 2206 into a first category and a second category. For example, the first category may comprise low-latency traffic. For example, the second category may comprise non-low latency traffic. In an example, AP 2202 negotiates with STA 2206 a TID-to-link mapping to assign traffic streams to available links. In an example, AP 2202 may prioritize different links based on the category of traffic. For example, AP 2202 may prioritize link 2 over link 1 for the communication of traffic of the first category.

As shown in FIG. 22, example 2200 may begin with AP 2202 transmitting a first frame 2212 to AP 2204 at a time T0. In an embodiment, first frame 2212 indicates a priority of link 2 for communicating traffic of the first category via link 2 by AP 2202. That is, the priority of link 2 represents the priority of link 2 being used by AP 2202 to communicate traffic of the first category via link 2. In an embodiment, first frame 2212 is transmitted via link 1 or link 2. In example 2200, first frame 2212 is transmitted via link 1. First frame 2212 may be an AP-to-AP frame. For example, AP-to-AP frame may be used for multi-AP coordination between AP 2202 and AP 2204.

In an embodiment, the priority of link 2 may indicate that AP 2202 communicates exclusively traffic of the first category via link 2. In another embodiment, the priority of link 2 may indicate that AP 2202 does not communicate traffic of the first category via link 2.

In an example, a traffic stream of the first category between AP 2202 and STA 2206 may be mapped to link 2. In an embodiment, the first category comprises low latency traffic.

In an embodiment, first frame 2212 may further indicate a priority of link 1 for communicating traffic of the first category via link 1 by AP 2202. In an example, the priority of link 1 may be lower than the priority of link 2. That is, AP 2202 prioritizes the use of link 2 over the use of link 1 for communicating traffic of the first category by AP 2202.

In an embodiment, first frame 2212 may be a management frame. In an embodiment, the management frame may be a beacon frame. In another embodiment, the management frame may be an action frame.

In an embodiment, AP 2204 may transmit a frame 2214 via link 1 in response to first frame 2212. In an embodiment, AP 2204 may not transmit a frame in response to first frame 2212 when first frame 2212 is a beacon frame.

In an embodiment, AP 2204 may have traffic of a second category for transmission to AP 2202. The second category may comprise non-low latency traffic. For example, the traffic of the second category may comprise AP-to-AP traffic used for coordination between AP 2202 and AP 2204.

In an embodiment, AP 2204 may select between link 1 and link 2 for the transmission of the traffic of the second category. In an embodiment, AP 2202 may select between link 1 and link 2 for the transmission of the traffic of the second category, based on the priority of link 1 and/or the priority of link 2 indicated in first frame 2212. In an embodiment, AP 2204 selects link 1 based on the priority of link 2. For example, the priority of link 2 may indicate that link 2 is used by AP 2202 exclusively for traffic of the first category. In another embodiment, AP 2204 selects link 1 based on the priority of link 2 and the priority of link 1. In an example, AP 2204 compares the priority of link 2 with the priority of link 1. For example, the priority of link 2 may be higher than the priority of link 1. As such, AP 2202 may select link 1 rather than link 2 to transmit traffic that is not of the first category, such as the traffic of the second category.

In example 2200, AP 2204 transmits a second frame 2216 comprising the traffic of the second category via link 1 to AP 2202. As shown in FIG. 22, second frame 2216 may be received by AP 2202 at a time T1. Second frame 2216 may be an AP-to-AP frame. For example, the AP-to-AP frame may be used for multi-AP coordination between AP 2202 and AP 2204. In an example, AP 2202 transmits a frame 2218 via link 1 in response to second frame 2216.

In example 2200, traffic of the first category may arrive at STA 2206 for transmission to AP 2202 before or after the time T1. In an example, as AP 2204 selects link 1 to transmit second frame 2216, STA 2206 may be enabled to transmit a frame 2222 comprising the traffic of the first category via link 2 to AP 2202. In an example, STA 2206 may transmit frame 2222 to AP 2202 via link 2 starting at a time T2 while AP 2202 receives frame 2216 via link 1 from AP 2204. As a result, the traffic of the first category may be delivered successfully and in a more timely fashion to AP 2202.

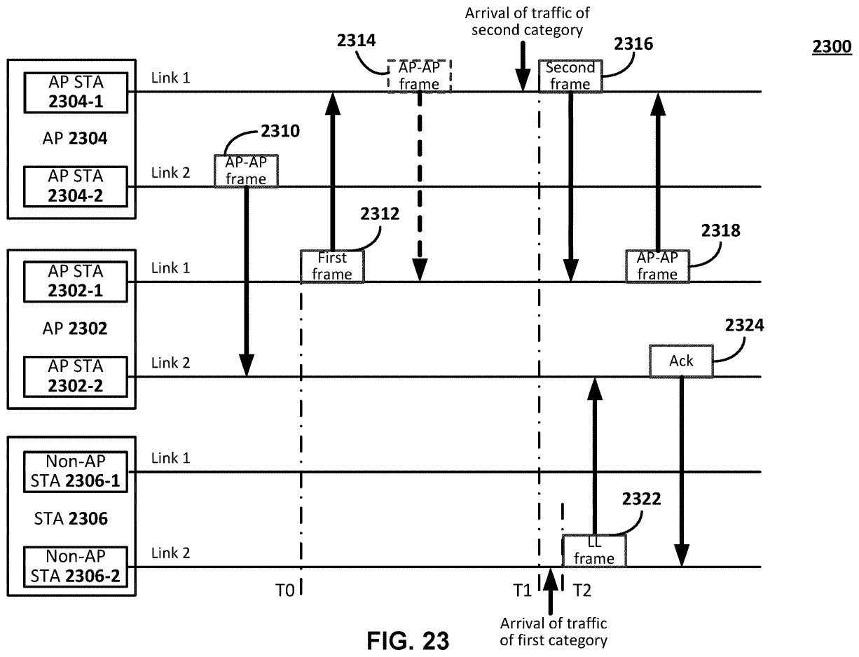

FIG. 23 illustrates another example 2300 of a multi-AP coordination procedure in a multi-link environment according to an embodiment. Example 2300 is provided for the purpose of illustration only and is not limiting. As shown in FIG. 23, example 2300 includes APs 2302 and 2304 and a STA 2306. AP 2302 and/or AP 2304 may comprise an AP MLD. STA 2306 may comprise a non-AP MLD. In an example, AP 2302 includes an affiliated AP STA 2302-1 and an affiliated AP STA 2302-2. In an example, AP 2304 includes an affiliated AP STA 2304-1 and an affiliated AP STA 2304-2. In an example, STA 2306 includes an affiliated non-AP STA 2306-1 and an affiliated non-AP STA 2306-2. In an example, AP STA 2302-1, AP STA 2304-1, and non-AP STA 2306-1 operate on a first link (link 1). The first link may comprise one of the 2.4 GHz band, the 5 GHz band, the 6 GHz band, or a future to be defined band. In an example, non-AP STA 2306-1 is associated with AP STA 2302-1. In an example, AP STA 2302-2, AP STA 2304-2, and non-AP STA 2306-2 operate on a second link (link 2). The second link may comprise one of the 2.4 GHz band, the 5 GHz band, the 6 GHz band, or a future to be defined band, with the second link being different from the first link.

In an example, APs 2302 and 2304 may belong to the same ESS. In such a case, APs 2302 and 2304 may be connected by a DS to support ESS features. In addition, as part of a coordinated AP set, APs 2302 and 2304 may be connected by a backhaul. For example, as shown in FIG. 23, APs 2302 and 2304 may be connected by a wireless backhaul comprising link 1 and link 2. In an example, non-AP STA 2306-2 is associated with AP STA 2302-2. In an example, AP STAs 2302-1 and 2304-1 belong to different BSSs. In another example, AP STAs 2302-2 and 2304-2 belong to different BSSs.

In an embodiment, AP 2302 and AP 2304 form a multi-AP group. In an example, AP STA 2302-1 and AP STA 2304-1 form a multi-AP group. In another example, AP STA 2302-2 and AP STA 2304-2 form a multi-AP group.

It is assumed in example 2300 that AP 2302 and STA 2306 completed a multi-link setup. During the multi-link setup, AP 2302 may classify traffic between AP 2302 and STA 2306 into one or more categories based on latency requirements of the traffic. For example, AP 2302 may classify traffic between AP 2302 and STA 2306 into a first category and a second category. For example, the first category may comprise low-latency traffic. For example, the second category may comprise non-low latency traffic. In an example, AP 2302 negotiates with STA 2306 a TID-to-link mapping to assign traffic streams to available links. In an example, AP 2302 may prioritize different links based on the category of traffic. For example, AP 2302 may prioritize link 2 over link 1 for the communication of traffic of the first category.

As shown in FIG. 23, example 2300 may begin with AP 2304 transmitting a frame 2310 to AP 2302 via link 2 to solicit a first frame 2312 from AP 2302. In an embodiment, AP 2302 transmits to AP 2304 first frame 2312 in response to frame 2310 at a time T0. In an embodiment, first frame 2312 indicates a priority of link 2 for communicating traffic of the first category via link 2 by AP 2302. That is, the priority of link 2 represents the priority of link 2 being used by AP 2302 to communicate traffic of the first category via link 2. In an embodiment, first frame 2312 is transmitted via link 1 or link 2. In example 2300, first frame 2312 is transmitted via link 1. First frame 2312 may be an AP-to-AP frame. For example, AP-to-AP frame may be used for multi-AP coordination between AP 2302 and AP 2304.

In an embodiment, the priority of link 2 may indicate that AP 2302 communicates exclusively traffic of the first category via link 2. In another embodiment, the priority of link 2 may indicate that AP 2302 does not communicate traffic of the first category via link 2.

In an example, a traffic stream of the first category between AP 2302 and STA 2306 may be mapped to link 2. In an embodiment, the first category comprises low latency traffic.

In an embodiment, first frame 2312 may further indicate a priority of link 1 for communicating traffic of the first category via link 1 by AP 2302. In an example, the priority of link 1 may be lower than the priority of link 2. That is, AP 2302 prioritizes the use of link 2 over the use of link 1 for communicating traffic of the first category by AP 2302.

In an embodiment, first frame 2312 may be a management frame. In an embodiment, the management frame may be a beacon frame. In another embodiment, the management frame may be an action frame.

In an embodiment, AP 2304 may transmit a frame 2314 via link 1 in response to first frame 2312. In an embodiment, AP 2304 may not transmit a frame in response to first frame 2312 when first frame 2312 is a beacon frame.

In an embodiment, AP 2304 may have traffic of a second category for transmission to AP 2302. The second category may comprise non-low latency traffic. For example, the traffic of the second category may comprise AP-to-AP traffic used for coordination between AP 2302 and AP 2304.

In an embodiment, AP 2304 may select between link 1 and link 2 for the transmission of the traffic of the second category. In an embodiment, AP 2302 may select between link 1 and link 2 for the transmission of the traffic of the second category, based on the priority of link 1 and/or the priority of link 2 indicated in first frame 2312. In an embodiment, AP 2304 selects link 1 based on the priority of link 2. For example, the priority of link 2 may indicate that link 2 is used by AP 2302 exclusively for traffic of the first category. In another embodiment, AP 2304 selects link 1 based on the priority of link 2 and the priority of link 1. In an example, AP 2304 compares the priority of link 2 with the priority of link 1. For example, the priority of link 2 may be higher than the priority of link 1. As such, AP 2302 may select link 1 rather than link 2 to transmit traffic that is not of the first category, such as the traffic of the second category.

In example 2300, AP 2304 transmits a second frame 2316 comprising the traffic of the second category via link 1 to AP 2302. As shown in FIG. 23, second frame 2316 may be received by AP 2302 at a time T1. Second frame 2316 may be an AP-to-AP frame. For example, the AP-to-AP frame may be used for multi-AP coordination between AP 2302 and AP 2304. In an example, AP 2302 transmits a frame 2318 via link 1 in response to second frame 2316.

In example 2300, traffic of the first category may arrive at STA 2306 for transmission to AP 2302 before or after the time T1. In an example, as AP 2304 selects link 1 to transmit second frame 2316, STA 2306 may be enabled to transmit a frame 2322 comprising the traffic of the first category via link 2 to AP 2302. In an example, STA 2306 may transmit frame 2322 to AP 2302 via link 2 starting at a time T2 while AP 2302 receives frame 2316 via link 1 from AP 2304. As a result, the traffic of the first category may be delivered successfully and in a more timely fashion to AP 2302.

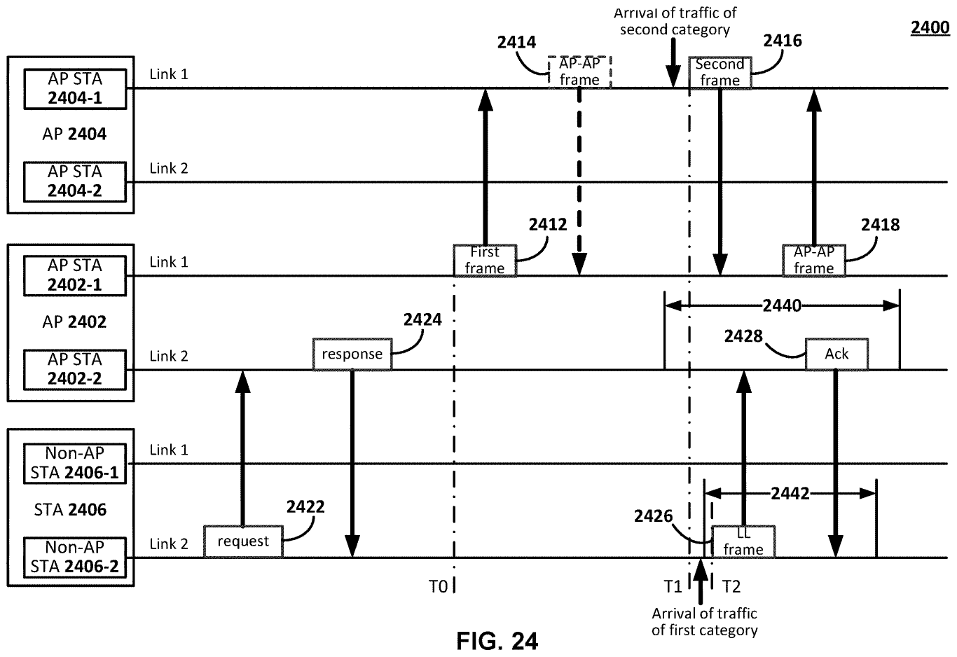

FIG. 24 illustrates another example 2400 of a multi-AP coordination procedure in a multi-link environment according to an embodiment. Example 2400 is provided for the purpose of illustration only and is not limiting. As shown in FIG. 24, example 2400 includes APs 2402 and AP 2404 and a STA 2406. AP 2402 and/or AP 2404 may comprise an AP MLD. STA 2406 may comprise a non-AP MLD. In an example, AP 2402 includes an affiliated AP STA 2402-1 and an affiliated AP STA 2402-2. In an example, AP 2404 includes an affiliated AP STA 2404-1 and an affiliated AP STA 2404-2. In an example, STA 2406 includes an affiliated non-AP STA 2406-1 and an affiliated non-AP STA 2406-2. In an example, AP STA 2402-1, AP STA 2404-1, and non-AP STA 2406-1 operate on a first link (link 1). The first link may comprise one of the 2.4 GHz band, the 5 GHz band, the 6 GHz band, or a future to be defined band. In an example, non-AP STA 2406-1 is associated with AP STA 2402-1. In an example, AP STA 2402-2, AP STA 2404-2, and non-AP STA 2406-2 operate on a second link (link 2). The second link may comprise one of the 2.4 GHz band, the 5 GHz band, the 6 GHz band, or a future to be defined band, with the second link being different from the first link.

In an example, APs 2402 and 2404 may belong to the same ESS. In such a case, APs 2402 and 2404 may be connected by a DS to support ESS features. In addition, as part of a coordinated AP set, APs 2402 and 2404 may be connected by a backhaul. For example, as shown in FIG. 24, AP 2402 and AP 2404 may be connected by a wireless backhaul comprising link 1 and link 2. In an example, non-AP STA 2406-2 is associated with AP STA 2402-2. In an example, AP STAs 2402-1 and 2404-1 belong to different BSSs. In another example, AP STAs 2402-2 and 2404-2 belong to different BSSs.

In an embodiment, AP 2402 and AP 2404 form a multi-AP group. In an example, AP STA 2402-1 and AP STA 2404-1 form a multi-AP group. In another example, AP STA 2402-2 and AP STA 2404-2 form a multi-AP group.

It is assumed in example 2400 that AP 2402 and STA 2406 completed a multi-link setup. During the multi-link setup, AP 2402 may classify traffic between AP 2402 and STA 2406 into one or more categories based on latency requirements of the traffic. For example, AP 2402 may classify traffic between AP 2402 and STA 2406 into a first category and a second category. For example, the first category may comprise low-latency traffic. For example, the second category may comprise non-low latency traffic. In an example, AP 2402 negotiates with STA 2406 a TID-to-link mapping to assign traffic streams to available links. In an example, AP 2402 may prioritize different links based on the category of traffic. For example, AP 2402 may prioritize link 2 over link 1 for the communication of traffic of the first category.

In an example, AP 2402 may schedule an R-TWT session with STA 2406 to enable STA 2406 to deliver traffic of the first category. For example, prior to the beginning of example 2400, AP 2402 and STA 2406 may exchange TWT setup request/response frames to set up an R-TWT SP 2442 for a TID associated with traffic of the first category.

In an example, as shown in FIG. 24, example 2400 may begin with a stream classification service (SCS) procedure between STA 2406 and AP 2402. The SCS procedure enables STA 2406 to signal to AP 2402 a QoS Characteristics element for a traffic stream to be delivered during R-TWT SPs of an R-TWT schedule. Specifically, STA 2406 may transmit a request frame 2422 to AP 2402 via link 2 to inform AP 2402 of a traffic stream of the first category at STA 2406. In an example, frame 2422 may be an SCS request frame. For example, frame 2422 includes a QoS Characteristics element indicating R-TWT SP 2442 and a TID for the traffic of the first category. In response to frame 2422, AP 2402 may transmit a response frame 2424 accepting the SCS request contained in frame 2422. For example, frame 2424 may be an SCS response frame.

Subsequently, as shown in FIG. 24, AP 2402 transmits a first frame 2412 to AP 2404 at time T0. In an embodiment, first frame 2412 indicates a priority of link 2 for communicating traffic of the first category via link 2 by AP 2402. That is, the priority of link 2 represents the priority of link 2 being used by AP 2402 to communicate traffic of the first category via link 2. In an embodiment, first frame 2412 is transmitted via link 1 or link 2. In example 2400, first frame 2412 is transmitted via link 1. First frame 2412 may be an AP-to-AP frame. For example, AP-to-AP frame may be used for multi-AP coordination between AP 2402 and AP 2404.

In an embodiment, the priority of link 2 indicates that the AP 2402 communicates exclusively traffic of the first category via link 2. In another embodiment, the priority of link 2 indicates that AP 2402 does not communicate traffic of the first category via link 2.

In an example, a traffic stream of the first category between AP 2402 and STA 2406 may be mapped to link 2. In an embodiment, the first category comprises low latency traffic.

In an embodiment, first frame 2412 may further indicate a priority of link 1 for communicating traffic of the first category via link 1 by AP 2402. In an example, the priority of link 1 may be lower than the priority of link 2. That is, AP 2402 prioritizes the use of link 2 over the use of link 1 for communicating traffic of the first category by AP 2402.

In an embodiment, first frame 2412 further includes a period 2440 for communicating traffic of the first category via link 2 by AP 2402. As shown in FIG. 24, period 2440 may start earlier than R-TWT SP 2442 and may end later than R-TWT SP 2442. In an example, period 2440 may be same as R-TWT SP 2442. In an example, period 2440 may be used to protect the transmission of the traffic of the first category on link 2 between AP 2402 and STA 2406. For example, by including period 2440 in first frame 2412, AP 2402 may avoid AP 2404 using link 2 to communicate traffic that is not of the first category during period 2440.

In an embodiment, first frame 2412 may be a management frame. In an embodiment, the management frame may be a beacon frame. In another embodiment, the management frame may be an action frame.

In an embodiment, AP 2404 may not transmit a frame 2414 in response to first frame 2412 when first frame 2412 is a beacon frame.

In an embodiment, AP 2404 may have traffic of a second category for transmission to AP 2402. The second category may comprise non-low latency traffic. For example, the traffic of the second category may comprise AP-to-AP traffic used for coordination between AP 2402 and AP 2404.

In an embodiment, AP 2404 may select between link 1 and link 2 for the transmission of the traffic of the second category. In an embodiment, AP 2402 may select between link 1 and link 2 for the transmission of the traffic of the second category, based on the priority of link 1, the priority of link 2, and/or period 2440 indicated in first frame 2412. In an embodiment, AP 2404 may select link 1 based on the priority of link 2 and period 2440. For example, the priority of link 2 and period 2440 may indicate that period 2440 on link 2 is used by AP 2402 exclusively for traffic of the first category. In another embodiment, AP 2404 may select link 1 based on the priority of link 2, the priority of link 1, and period 2440. In an example, AP 2404 may compare the priority of link 2 with the priority of link 1 within period 2440. For example, the priority of link 2 may be higher than the priority of link 1 within period 2440. As such, AP 2402 may select link 1 rather than link 2 within period 2440 to transmit traffic that is not of the first category, such as the traffic of the second category.

In example 2400, AP 2404 may transmit a second frame 2416 comprising the traffic of the second category via link 1 within period 2440. As shown in FIG. 24, second frame 2416 may be received by AP 2402 at a time T1. Second frame 2416 may be an AP-to-AP frame. For example, the AP-to-AP frame may be used for multi-AP coordination between AP 2402 and AP 2404. In an example, AP 2402 may transmit a frame 2418 via link 1 in response to frame 2416.

In example 2400, traffic of the first category may arrive at STA 2406 for transmission to AP 2402 before or after the time T1. In an example, as AP 2404 selects link 1 to transmit second frame 2416, STA 2406 may be enabled to transmit a frame 2426 comprising the traffic of the first category via link 2 to AP 2402. In an example, STA 2406 may transmit frame 2426 to AP 2402 via link 2 starting at a time T2 while AP 2402 receives frame 2416 via link 1 from AP 2404. As a result, the traffic of the first category may be delivered successfully and in a more timely fashion to AP 2402.

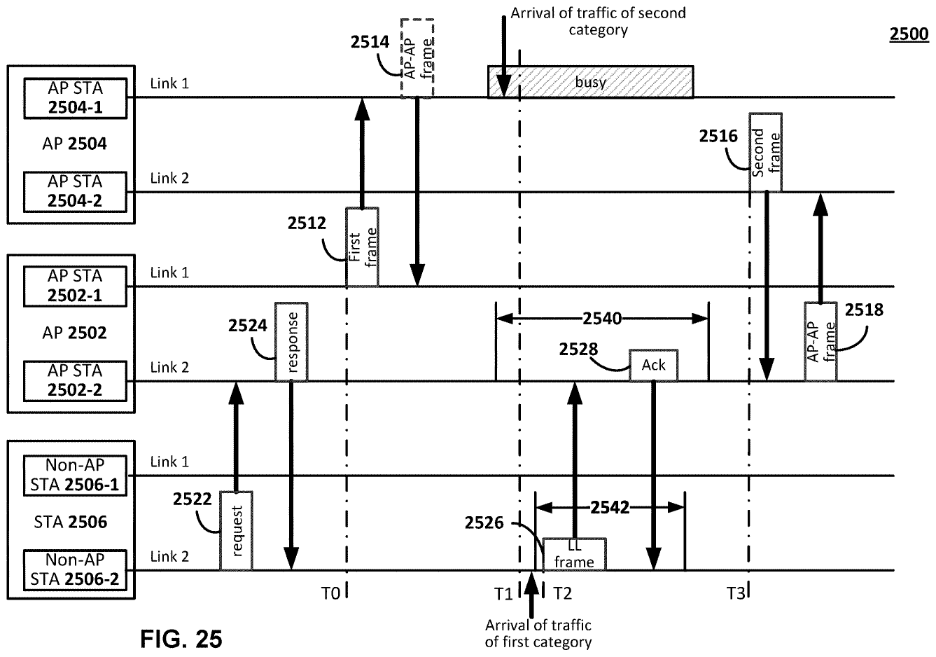

FIG. 25 illustrates another example 2500 of multi-AP coordination procedure according to an embodiment. Example 2500 is provided for the purpose of illustration only and is not limiting. As shown in FIG. 25, example 2500 includes APs 2502 and AP 2504 and a STA 2506. AP 2502 and/or AP 2504 may comprise an AP MLD. STA 2506 may comprise a non-AP MLD. In an example, AP 2502 includes an affiliated AP STA 2502-1 and an affiliated AP STA 2502-2. In an example, AP 2504 includes an affiliated AP STA 2504-1 and an affiliated AP STA 2504-2. In an example, STA 2506 includes an affiliated non-AP STA 2506-1 and an affiliated non-AP STA 2506-2. In an example, AP STA 2502-1, AP STA 2504-1, and non-AP STA 2506-1 operate on a first link (link 1). The first link may comprise one of the 2.4 GHz band, the 5 GHz band, the 6 GHz band, or a future to be defined band. In an example, non-AP STA 2506-1 is associated with AP STA 2502-1. In an example, AP STA 2502-2, AP STA 2504-2, and non-AP STA 2506-2 operate on a second link (link 2). The second link may comprise one of the 2.4 GHz band, the 5 GHz band, the 6 GHz band, or a future to be defined band, with the second link being different from the first link.

In an example, APs 2502 and 2504 may belong to the same ESS. In such a case, APs 2502 and 2504 may be connected by a DS to support ESS features. In addition, as part of a coordinated AP set, APs 2502 and 2504 may be connected by a backhaul. For example, as shown in FIG. 25, AP 2502 and AP 2504 may be connected by a wireless backhaul comprising link 1 and link 2. In an example, non-AP STA 2506-2 is associated with AP STA 2502-2. In an example, AP STAs 2502-1 and 2504-1 belong to different BSSs. In another example, AP STAs 2502-2 and 2504-2 belong to different BSSs.

In an embodiment, AP 2502 and AP 2504 form a multi-AP group. In an example, AP STA 2502-1 and AP STA 2504-1 form a multi-AP group. In another example, AP STA 2502-2 and AP STA 2504-2 form a multi-AP group.

It is assumed in example 2500 that AP 2502 and STA 2506 completed a multi-link setup. During the multi-link setup, AP 2502 may classify traffic between AP 2502 and STA 2506 into one or more categories based on latency requirements of the traffic. For example, AP 2502 may classify traffic between AP 2502 and STA 2506 into a first category and a second category. For example, the first category may comprise low-latency traffic. For example, the second category may comprise non-low latency traffic. In an example, AP 2502 negotiates with STA 2506 a TID-to-link mapping to assign traffic streams to available links. In an example, AP 2502 may prioritize different links based on the category of traffic. For example, AP 2502 may prioritize link 2 over link 1 for the communication of traffic of the first category.

In an example, AP 2502 may schedule an R-TWT session with STA 2506 to enable STA 2406 to deliver traffic of the first category. For example, prior to the beginning of example 2500, AP 2502 and STA 2506 may exchange TWT setup request/response frames to set up an R-TWT SP 2542 for a TID associated with traffic of the first category.

In an example, as shown in FIG. 25, example 2500 may begin with a SCS procedure between STA 2506 and AP 2502. The SCS procedure enables STA 2506 to signal a QoS Characteristics element for a traffic stream to be delivered during R-TWT SPs of an R-TWT schedule.

Specifically, STA 2506 may transmit a request frame 2522 to AP 2502 via link 2 to inform AP 2502 of a traffic stream of the first category at STA 2506. In an example, frame 2522 may be an SCS request frame. For example, frame 2522 includes a QoS Characteristics element indicating R-TWT SP 2542 and a TID for the traffic of the first category. In response to frame 2522, AP 2502 may transmit a response frame 2524 accepting the SCS request contained in frame 2522. For example, frame 2524 may be an SCS response frame.

Subsequently, as shown in FIG. 25, AP 2502 transmits a first frame 2512 to AP 2504 at time T0. In an embodiment, first frame 2512 indicates a priority of link 2 for communicating traffic of the first category via link 2 by AP 2502. That is, the priority of link 2 represents the priority of link 2 being used by AP 2502 to communicate traffic of the first category via link 2. In an embodiment, first frame 2512 is transmitted via link 1 or link 2. In example 2500, first frame 2512 is transmitted via link 1. First frame 2512 may be an AP-to-AP frame. For example, AP-to-AP frame may be used for multi-AP coordination between AP 2502 and AP 2504.

In an embodiment, the priority of link 2 indicates that the AP 2502 communicates exclusively traffic of the first category via link 2. In another embodiment, the priority of link 2 indicates that AP 2502 does not communicate traffic of the first category via link 2.

In an example, a traffic stream of the first category between AP 2502 and STA 2506 may be mapped to link 2. In an embodiment, the first category comprises low latency traffic.

In an embodiment, first frame 2512 may further indicate a priority of link 1 for communicating traffic of the first category via link 1 by AP 2502. In an example, the priority of link 1 may be lower than the priority of link 2. That is, AP 2502 prioritizes the use of link 2 over the use of link 1 for communicating traffic of the first category by AP 2502.

In an embodiment, first frame 2512 further includes a period 2540 for communicating traffic of the first category via link 2 by AP 2502. As shown in FIG. 25, period 2540 may start earlier than R-TWT SP 2542 and may end later than period R-TWT SP 2542. In an example, period 2540 may be same as R-TWT SP 2542. In an example, period 2540 may be used to protect the transmission of the traffic of the first category on link 2 between AP 2502 and STA 2506. For example, by including period 2540 in first frame 2512, AP 2502 may avoid AP 2504 using link 2 to communicate traffic that is not of the first category during period 2540.

In an embodiment, first frame 2512 may be a management frame. In an embodiment, the management frame may be a beacon frame. In another embodiment, the management frame may be an action frame.

In an embodiment, AP 2504 may not transmit a frame 2514 in response to first frame 2512 when first frame 2512 is a beacon frame.

In an embodiment, AP 2504 may have traffic of a second category for transmission to AP 2502. The second category may comprise non-low latency traffic. For example, the traffic of the second category may comprise AP-to-AP traffic used for coordination between AP 2502 and AP 2504.

As shown in FIG. 25, AP 2504 may be busy on link 1 during the period 2540. In an embodiment, AP 2504 may select between link 1 and link 2 for the transmission of the traffic of the second category. In an embodiment, AP 2502 may select between link 1 and link 2 for the transmission of the traffic of the second category, based on the priority of link 1, the priority of link 2, and/or period 2540 indicated in first frame 2512. In an embodiment, AP 2504 may select link 2 based on the priority of link 2, and the period 2540. For example, the priority of link 2 and period 2540 may indicate that period 2540 on link 2 is used by AP 2502 exclusively for traffic of the first category. In another embodiment, AP 2504 may select link 2 based on the priority of link 2, the priority of link 1, and period 2540. In an example, AP 2504 may compare the priority of link 2 with the priority of link 1 within period 2540. For example, the priority of link 2 may be higher than the priority of link 1 within period 2540. For example, AP 2504 may be busy on link 1 within period 2540. As such, AP 2502 may select link 2 rather than link 1 after period 2540 to transmit traffic that is not of the first category, such as the traffic of the second category.

In example 2500, AP 2504 may transmit a second frame 2516 comprising the traffic of the second category via link 2 within period 2540. As shown in FIG. 25, second frame 2516 may be received by AP 2502 at a time T3 after the end of period 2540. Frame 2516 may be an AP-to-AP frame. For example, the AP-to-AP frame may be used for multi-AP coordination between AP 2502 and AP 2504. In an example, AP 2502 may transmit a frame 2518 via link 2 in response to frame 2516. In another example, AP 2502 may transmit frame 2518 via link 1 in response to frame 2516.

In example 2500, traffic of the first category may arrive at STA 2506 for transmission to AP 2502 before or after a time T1. In an example, as AP 2504 selects link 2 to transmit second frame 2516, STA 2506 may be enabled to transmit a frame 2526 comprising the traffic of the first category via link 2 to AP 2502. In an example, STA 2506 may transmit frame 2526 to AP 2502 via link 2 starting at a time T2 before AP 2502 receives frame 2516 via link 2 at T3. As a result, the traffic of the first category may be delivered successfully and in a more timely fashion to AP 2502.

In an embodiment, first frame 2212 described in FIG. 22, first frame 2312 described in FIG. 23, first frame 2412 described in FIG. 24, and first frame 2512 described in FIG. 25 may be management frames, such as beacon frames.

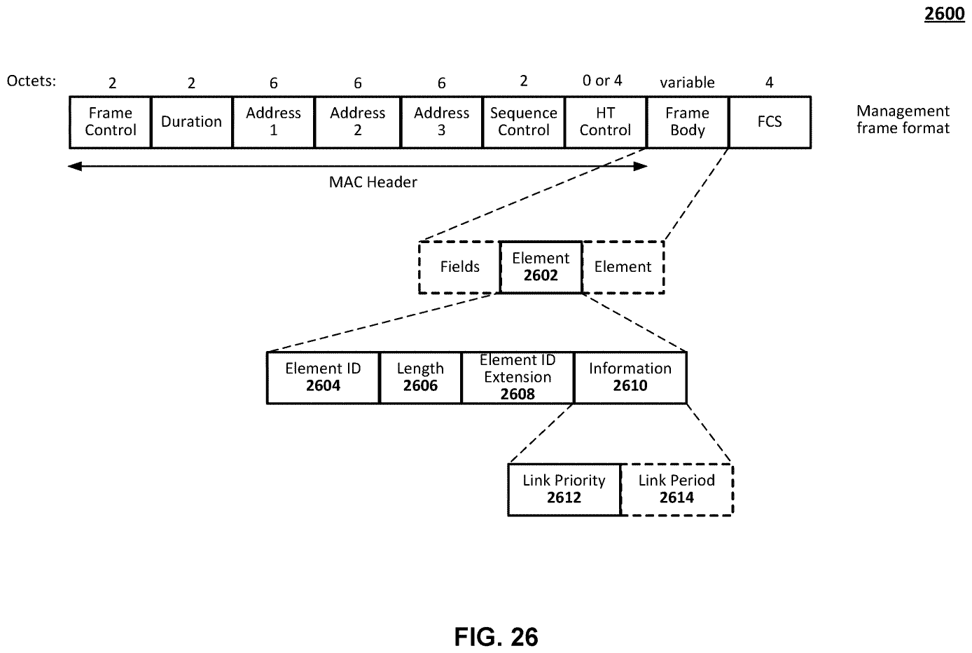

FIG. 26 illustrates an example beacon frame 2600 which may be used according to embodiments. For example, beacon frame 2600 may be an embodiment of frames 2212, 2312, 2412, and 2512. In an embodiment, beacon frame 2600 may indicate a priority of a first link, of a plurality of links, for communicating traffic of a first category via the first link by an AP. The first link may comprise one of the 2.4 GHz band, the 5 GHz band, the 6 GHz band, or a future to be defined band. In an embodiment, beacon frame 2600 may further indicate a priority of a second link, of a plurality of links, for communicating traffic of a first category via the second link by an AP. The second link may comprise one of the 2.4 GHz band, the 5 GHz band, the 6 GHz band, or a future to be defined band, with the second link being different from the first link. In an embodiment, beacon frame 2600 may further include a period for communicating traffic of the first category via the first link by the AP.

As shown in FIG. 26, beacon frame 2600 may include a frame control field, a duration field, one or more address fields, a sequence control field, an HT control field, a frame body, and an FCS field. In an embodiment, the frame body may include an element 2602 indicating the priority of the first link. In an example, element 2602 may include an element identifier (ID) field 2604, a length field 2606, an element ID extension field 2608, and an information field 2610. In an embodiment, the frame body may include a further element such as element 2602 to indicate the priority of the second link.

In an example, information field 2610 may include a link priority subfield 2612 and an optional link period subfield 2614.

In an embodiment, link priority subfield 2612 may include the priority of the first link. In an embodiment, link priority subfield 2612 may further include the priority of the second link. In an implementation, link priority subfield 2612 may include at least one value from a list of priority values. In an implementation, a priority value with a higher (or lower) value indicates that the link has higher priority for communicating traffic of the first category by the AP. In another implementation, link priority subfield 2612 may take a 0 or 1 value, where a value of 1 indicates that the first link is dedicated for communicating traffic of the first category by the AP.

In an embodiment, link period subfield 2614 may include the period for communicating traffic of the first category via the first link by the AP. In an implementation, link period subfield 2614 may include a starting time of the period and a duration of the period. In another implementation, link period subfield 2614 may include a starting time of the period and an ending time of the period.

In an embodiment, first frame 2212 described in FIG. 22, first frame 2312 described in FIG. 23, first frame 2412 described in FIG. 24, and first frame 2512 described in FIG. 25 may be management frames, such as action frames.

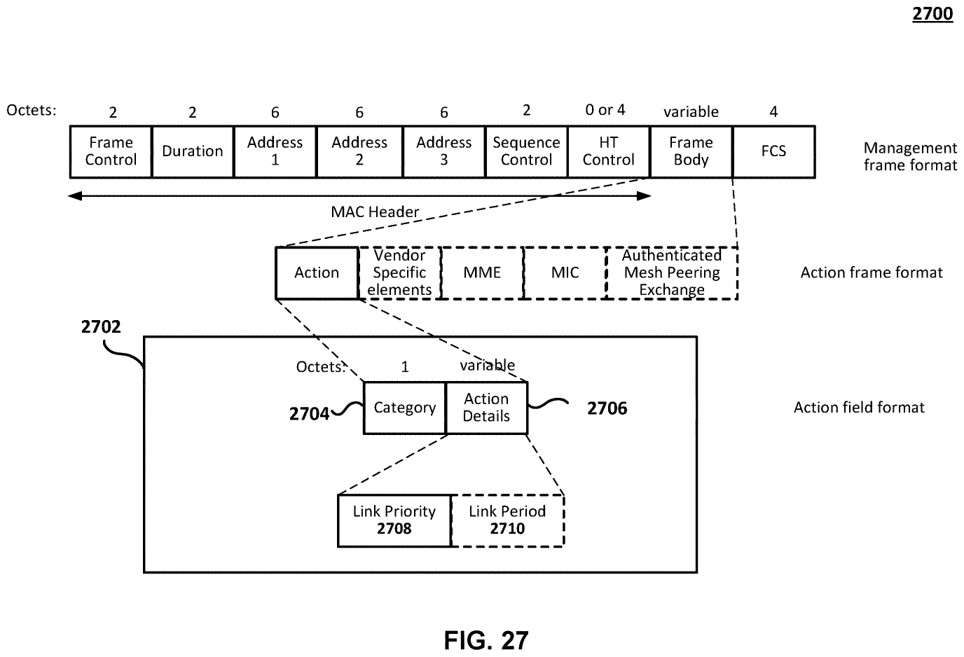

FIG. 27 illustrates an example action frame 2700 which may be used according to embodiments. For example, action frame 2700 may be an embodiment of frames 2212, 2312, 2412, and 2512. In an example, action frame 2700 may be a public action frame. In an embodiment, action frame 2700 may include a priority of a first link, of a plurality of links, for communicating traffic of a first category via the first link by an AP. The first link may comprise one of the 2.4 GHz band, the 5 GHz band, the 6 GHz band, or a future to be defined band. In an embodiment, action frame 2700 may further indicate a priority of a second link, of a plurality of links, for communicating traffic of a first category via the second link by an AP. The second link may comprise one of the 2.4 GHz band, the 5 GHz band, the 6 GHz band, or a future to be defined band, with the second link being different from the first link. In an embodiment, action frame 2700 may further include a period for communicating traffic of the first category via the first link by the AP.

As shown in FIG. 27, action frame 2700 may include an action field 2702. In an embodiment, action field 2702 may include a category subfield 2704 for indicating link priority. In an example, the action field 2702 may include an action details field 2706. In an example, the action details field 2706 may include a link priority subfield 2708 and an optional link period subfield 2710.

In an embodiment, link priority subfield 2708 may include the priority of the first link. In an embodiment, link priority subfield 2708 may further include the priority of the second link. In an implementation, link priority subfield 2708 may include at least one value from a list of priority values. In an implementation, a priority value with a higher (or lower) value indicates that the link has higher priority for communicating traffic of the first category by the AP. In another implementation, link priority subfield 2708 may take a 0 or 1 value, where a value of 1 indicates that the first link is dedicated for communicating traffic of the first category by the AP.

In an embodiment, link period subfield 2710 may include the period for communicating traffic of the first category via the first link by the AP. In an implementation, link period subfield 2710 may include a starting time of the period and a duration of the period. In another implementation, link period subfield 2710 may include a starting time of the period and an ending time of the period.

As would be understood by a person of skill in the art based on the teachings herein, the embodiments as described by the above examples may be readily extended to cases including more than two links.

As would be understood by a person of skill in the art based on the teachings herein, the embodiments as described by the above examples may be readily extended to cases including more than two APs.

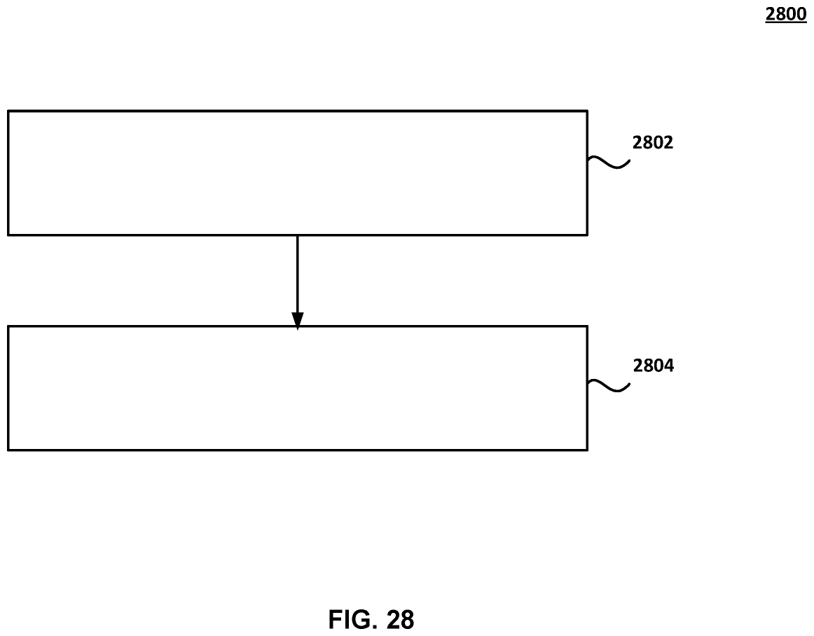

FIG. 28 illustrates an example process 2800 according to an embodiment. Example process 2800 is provided for the purpose of illustration only and is not limiting of embodiments. Process 2800 may be performed by a first AP.

As shown in FIG. 28, process 2800 begins in step 2802, which includes receiving, by the first AP from a second AP, a first frame indicating a priority of a first link, of a plurality of links, for communicating traffic of a first category via the first link by the second AP.

In an embodiment, receiving the first frame comprises receiving the first frame via a first link or a second link. In an embodiment, the priority of the first link indicates that the second AP communicates exclusively traffic of the first category via the first link. In an embodiment, the priority of the first link indicates that the second AP does not communicate traffic of the first category via the first link. In an example, the first link may comprise one of a 2.4 GHz band, a 5 GHz band, a 6 GHz band, or a future to be defined band. Similarly, the second link may comprise one of the 2.4 GHz band, the 5 GHz band, the 6 GHz band, or a future to be defined band, with the second link being different from the first link.

In an embodiment, a traffic stream of the first category is mapped to the first link at the second AP. In an embodiment, the traffic of the first category comprises low latency traffic. In an embodiment, the traffic of the first category comprises traffic between the second AP and a first STA associated with the second AP.

In an embodiment, the first frame further indicates a priority of the second link for communicating traffic of the first category via the second link by the second AP.

In an embodiment, the first frame further comprises a period for communicating traffic of the first category via the first link by the second AP.

In an embodiment, the first frame comprises a management frame. In an embodiment, the management frame comprises a beacon frame comprising an element indicating the priority of the first link. In an embodiment, the management frame comprises an action frame comprising an action field indicating the priority of the first link.

In an embodiment, further comprising transmitting, by the first AP to the second AP, a third frame to solicit the first frame.

In an embodiment, further comprising transmitting, by the first AP to the second AP, a fourth frame in response to the first frame.

In step 2804, process 2800 includes, transmitting, by the first AP to the second AP, via a second link of the plurality of links, a second frame comprising traffic of a second category, the second link selected based on the priority of the first link.

In an embodiment, transmitting the second frame comprises transmitting the second frame to the second AP or to a second STA. In an embodiment, the traffic of the second category comprises traffic between the first AP and the second AP.

In an embodiment, the first AP and the second AP form a multi-AP group.

In an embodiment, the first AP or the second AP comprises a multi-link device (MLD).

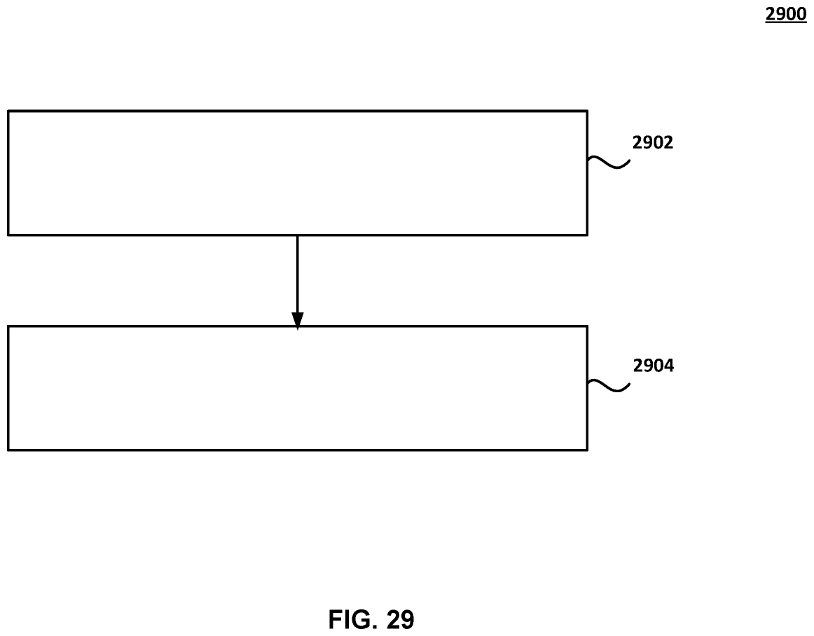

FIG. 29 illustrates an example process 2900 according to an embodiment. Example process 2900 is provided for the purpose of illustration only and is not limiting of embodiments. Process 2900 may be performed by a first AP.

As shown in FIG. 29, process 2900 begins in step 2902, which includes transmitting, by the first AP to a second AP, a first frame indicating a priority of a first link, of a plurality of links, for communicating traffic of a first category via the first link by the first AP.

In an embodiment, transmitting the first frame comprises transmitting the first frame via the first link or the second link. In an embodiment, the priority of the first link indicates that the first AP communicates exclusively traffic of the first category via the first link. In an embodiment, the priority of the first link indicates that the first AP does not communicate traffic of the first category via the first link. In an example, the first link may comprise one of a 2.4 GHz band, a 5 GHz band, a 6 GHz band, or a future to be defined band. Similarly, the second link may comprise one of the 2.4 GHz band, the 5 GHz band, the 6 GHz band, or a future to be defined band, with the second link being different from the first link.

In an embodiment, a traffic stream of the first category is mapped to the first link at the first AP. In an embodiment, the traffic of the first category comprises low latency traffic.

In an embodiment, the first frame further indicates a priority of the second link for communicating traffic of the first category via the second link by the first AP.

In an embodiment, the first frame further comprises a period for communicating traffic of the first category via the first link by the first AP.

In an embodiment, the first frame comprises a management frame. In an embodiment, the management frame comprises a beacon frame comprising an element indicating the priority of the first link. In an embodiment, the management frame comprises an action frame comprising an action field indicating the priority of the first link.

In an embodiment, further comprising receiving, by the first AP from the second AP, a third frame to solicit the first frame.

In an embodiment, further comprising receiving, by the first AP from the second AP, a fourth frame in response to the first frame.

In step 2904, process 2900 includes receiving, by the first AP from the second AP, via a second link of the plurality of links, a second frame comprising traffic of a second category, the second link selected based on the priority of the first link.

In an embodiment, receiving the second frame comprises receiving the second frame from the first AP. In an embodiment, the traffic of the second category comprises traffic between the first AP and the second AP.

In an embodiment, the first AP and the second AP form a multi-AP group.

In an embodiment, the first AP or the second AP comprises a multi-link device (MLD).

1. (canceled)

2. A method comprising:
receiving, by a first access point (AP) from a second AP, a first frame indicating a priority of a first link, of a plurality of links, for communicating traffic of a first category via the first link by the second AP; and
transmitting, by the first AP, via a second link of the plurality of links, a second frame comprising traffic of a second category, the second link selected based on the priority of the first link.

3. The method of claim 2, wherein transmitting the second frame comprises transmitting the second frame to the second AP or to a first STA.

4. (canceled)

5. The method of claim 2, wherein the priority of the first link indicates that the second AP communicates exclusively traffic of the first category via the first link.

6. The method of claim 2 wherein the priority of the first link indicates that the second AP does not communicate traffic of the first category via the first link.

7. (canceled)

8. (canceled)

9. The method of claim 2, wherein the traffic of the first category comprises traffic between the second AP and a second STA associated with the second AP.

10. (canceled)

11. The method of claim 2, wherein the first frame further indicates a priority of the second link for communicating traffic of the first category via the second link by the second AP.

12. (canceled)

13. (canceled)

14. (canceled)

15. (canceled)

16. (canceled)

17. (canceled)

18. (canceled)

19. The method of claim 2, wherein receiving the second frame comprises receiving the second frame from the first AP.

20-40. (canceled)

41. A method comprising:
transmitting, by a first access point (AP) to a second AP, a first frame indicating a priority of a first link, of a plurality of links, for communicating traffic of a first category via the first link by the first AP; and
receiving, by the first AP from the second AP, via a second link of the plurality of links, a second frame comprising traffic of a second category, the second link selected based on the priority of the first link.

42. The method of claim 2 comprising selecting, by the first AP and based on the priority of the first link, a second link, for transmitting traffic of a second category to the second AP.
